(19) United States
(12) Patent Application Publication
(10) Pub. No.: US 2014/0061061 A1
(43) Pub. Date: Mar. 6, 2014

(54) ELECTROLYTIC TRANSFORMATION OF WATER CONTAMINANTS

(71) Applicants: Akram Alshawabkeh, Franklin, MA (US); Xuhui Mao, Malden, MA (US)

(72) Inventors: Akram Alshawabkeh, Franklin, MA (US); Xuhui Mao, Malden, MA (US)

(73) Assignee: NORTHEASTERN UNIVERSITY, Boston, MA (US)

(21) Appl. No.: 13/983,749

(22) PCT Filed: Feb. 6, 2012
(86) PCT No.: PCT/US2012/023917

§ 371 Date: Nov. 13, 2013

Related U.S. Application Data
(60) Provisional application No. 61/439,589, filed on Feb. 4, 2011.

(51) Int. Cl. C02F 1/461

(52) U.S. Cl. CPC C02F 1/46109
USPC 205/758; 204/660; 204/674; 205/761

(57) ABSTRACT

Methods and apparatuses to transform contaminants in water by electrolytic processes are described. In some embodiments, the apparatuses and electrolytic processes couple an anode comprising iron and a high specific surface area cathode. Methods and apparatuses described herein provide advantages over conventional apparatuses and methods such as, for example, cost savings, efficiency, environmentally benign impact and versality for a variety contaminants.

### CROSS-REFERENCE TO RELATED APPLICATION

This application claims priority to U.S. Provisional Application No. 61/439,589, filed on Feb. 4, 2011, the contents of which are incorporated herein by reference in their entireties.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### GOVERNMENT SUPPORT

This invention was made with United States government support under Grant No. P42ES017198 awarded by the Superfund Research Program of the National Institute of Environmental Health Sciences. The United States government has certain rights in the invention.

### FIELD OF THE INVENTION

The present disclosure relates to electrochemical transformation of water contaminants. More particularly, the present disclosure relates to electrolytic transformation of contaminants in groundwater.

### BACKGROUND OF THE INVENTION

Removal of contaminants from aqueous sources has been the focus of several processes. In particular, methods for removal of halogenated organics such as trichloroethylene from groundwater include phase-transfer processes, chemical transfer processes, electrochemical transformation and bioaugmentation/biotransformation. However, each of these methods present drawbacks. Phase-transfer processes do not change halogenated organics into less toxic or non-toxic compounds, thus still presenting environmental risks. Chemical processes intrinsically suffer from the requisite addition of additional chemicals that may be harmful to the environment. Bioaugmentation/biotransformation processes are relatively advantageous in terms of costs, but inactivity of bacteria and control of degradation rate both remain challenges.

Electrochemical methods for dehalogenation include 1) electrochemical reduction on a cathode in a separated electrolyte cell, 2) electrochemical reduction on a cathode in a mixed-electrolyte cell using an inert anode, and 3) electrochemical oxidation on high-cost anodes such as a boron-doped film electrode. These methods also suffer from drawbacks such as requirements for the use of expensive materials such as ion-exchange membranes and boron-doped film electrodes, or exhibit low dehalogenation rates that render the processes relatively inefficient. For example, electrochemical processes involve mass transfer for the target compound and concentrations of halogenated organics in contaminated aqueous media are relatively low. Thus, the efficiency of electrochemical reduction methods remain unacceptable for practical, large-scale applications.

Thus, there is a need for new methods and processes to remove water contaminants. There is also a need for innovative methods and processes for removal of water contaminants that improve cost and efficiency over the currently available methods, and that are suitable for field implementation. This invention addresses these needs.

### SUMMARY OF THE INVENTION

In one aspect, the invention is directed to an apparatus for reduction of contaminants in groundwater comprising,
(a) a metal iron anode,
(b) a high specific surface area cathode,
(c) a power supply in electrical communication with the anode and cathode, and
(d) optionally, a conduit for for introducing ground water into the apparatus,
   wherein when the conduit is not present, the anode and cathode are configured to enable introduction of the anode and cathode into a ground water source.

In a second aspect, the invention is directed to a method for reduction of contaminants in groundwater comprising:
(a) providing a metal iron anode and a high specific surface area cathode,
(b) placing the groundwater in electrical contact with the anode and cathode, and
(c) providing an electrical current between the anode and the cathode.

In some embodiments, the groundwater is from an aquifer, cistern, well, reservoir, spring, river or lake.

In some embodiments, the conduit is in contact with a groundwater source. In some embodiments, the anode and cathode are in contact with a groundwater source. In some embodiments, the anode and cathode are positioned in a groundwater source.

In some embodiments, the apparatus further comprises a second anode or a second cathode. In some embodiments, the apparatus further comprises a second anode. In some embodiments, the apparatus further comprises a second cathode. In some embodiments, the apparatus further comprises a pump configured to transfer groundwater from the groundwater source to the anode.

In some embodiments, the power supply comprises AC, DC, solar, wind or hydroelectric power.

In some embodiments, the anode comprises at least about 90% iron. In some embodiments, the anode comprises at least about 95% iron. In some embodiments, the anode comprises greater than about 95% iron.

In some embodiments, the anode is cast iron, mild steel, iron rod, iron plate, or scrap iron.

In some embodiments, the specific surface area of the cathode is from about 400 m²/m³ to about 6500 m²/m³. In some embodiments, the specific surface area of the cathode is about 5000 m²/m³.

In some embodiments, the cathode comprises metal foam, lead, vitreous carbon, copper plate or silver plate. In some embodiments, the cathode comprises metal foam, copper plate or silver plate. In some embodiments, the cathode comprises iron foam, copper foam or silver foam. In some embodiments, the cathode comprises copper foam or silver foam. In some embodiments, the cathode comprises copper foam.

In some embodiments, the cathode has a mean pore size of at least about 100 μM. In some embodiments, the cathode has a mean pore size of at least about 200 μM. In some embodiments, the cathode has a mean pore size of greater than about 200 μM.

In some embodiments, the anode and cathode are in an undivided cell.

In some embodiments, the contaminants are halogenated organics.

In some embodiments, reduction of contaminants is performed ex-situ. In some embodiments, the reduction of contaminants is performed within the groundwater. In some embodiments, the reduction of contaminants is performed within at least one circulation well. In some embodiments, the groundwater is fed to the anode from a groundwater source. In some embodiments, the groundwater is pumped from a groundwater source.

In some embodiments, the groundwater is not treated to modify conductivity.

### BRIEF DESCRIPTION OF THE FIGURES

The objects and advantages of the present invention will be apparent upon consideration of the following detailed description, taken in conjunction with the accompanying drawings, in which like reference characters refer to like parts throughout, and in which:

FIG. 1 is an exemplary embodiment wherein generation of iron cations at the anode facilitates reduction of contaminants.

FIG. 2 shows exemplary embodiments of implementation strategies for remediation of contaminated groundwater. FIG. 2A shows exemplary ex-situ treatment; FIG. 2B shows the electrolytic reactor within the well, wherein mixing and treatment occurs by groundwater flow;

FIG. 2C shows circulation (single for tandem) wells with electrolytic reactor within the wells;

FIG. 2D shows injection of electrolysis products by ion migration or other movements under an electrical field using, for example, a DC or solar panel as a power source.

FIG. 3 is an exemplary embodiment comprising a glass electrolytic cell.

FIG. 4 shows (A) decay of aqueous TCE concentration, (B) time profiles of electrolyte ORP, and (C) time profiles of molar ratio of headspace gases (ethene to ethane) in the cells using copper foam cathode and different anodes. Electrolysis current was 90 mA. Initial TCE concentration was around 39 mg L⁻¹. Control experiment was conducted without applying electrical current.

FIG. 5 shows headspace concentrations of hydrocarbon gases during electrolysis using copper foam cathode and different anodes. Sampling time is 0.5 h after electrolysis was started. Electrolysis conditions are as in FIG. 4.

FIG. 6 shows TCE degradation kinetics in the electrolyte containing 39 mg L⁻¹ TCE. Slopes of linear regression lines shown for each cathode data set represent the pseudo-first order rate constants for TCE reduction (k).

FIG. 7 shows average current efficiency (ACE) of TCE electrochemical reduction at different times and currents for 39 mg L⁻¹ initial concentration experiment set using copper foam cathode and cast iron anode.

FIG. 8 shows time profiles of electrolyte ORP at different electrolysis currents (39 mg L⁻¹ initial TCE concentration). The Fe²⁺ theoretic concentrations (dashed lines) were calculated based on Faraday's law using 100% current efficiencies (this is hypothetical and actual efficiencies are less than 100%). Copper foam cathode and cast iron anode. The arrows refer to the relevant Y-axis.

FIG. 9 shows effect of current on final pH of electrolyte and headspace gas composition (molar ratio of ethene to ethane). Initial concentration of aqueous TCE was around 39 mg L⁻¹ in all experiments.

FIG. 10 shows an exemplary embodiment of the apparatus of the invention comprising an electrochemical reactor, a recirculation pump and a glass reservoir.

FIG. 11 shows (A) decay of aqueous TCE concentration, (B) time profiles of chloride ion concentration, (C) time profiles of pH, and (D) time profiles of electrolyte ORP in the cells using silver plate cathode and different anodes.

FIG. 12 shows (A) mass of headspace hydrocarbon gases in the water reservoir after 1.5 h electrolysis, and (B) hydrodechlorination index using different anodes. All gas samples were collected from the headspace of water reservoir.

FIG. 13 shows (A) decay of normalized aqueous concentration of TCE using iron anode and different plate cathode materials, and (B) decay of normalized aqueous concentration of TCE using iron anode and different foam cathode materials. The initial concentration of aqueous TCE was 38 mg L⁻¹.

FIG. 14 shows a Pareto chart of single and interaction factors for (A) FEE response and (B) SEC response.

FIG. 15 shows contour plots of FEE of TCE for (A) Na₂SO₄ concentration versus current, (B) current versus thickness (Thk) of electrode, and (C) Na₂SO₄ concentration versus thickness of electrode.

### DETAILED DESCRIPTION OF THE INVENTION

All patents, patent applications and publications cited herein are hereby incorporated by reference in their entirety. The disclosures of these publications in their entireties are hereby incorporated by reference into this application in order to more fully describe the state of the art as known to those skilled therein as of the date of the invention described and claimed herein.

In one aspect, the invention is directed to an apparatus for reduction of contaminants in groundwater comprising,

(a) a metal iron anode,

(b) a high specific surface area cathode,

(c) a power supply in electrical communication with the anode and cathode, and

(d) optionally, a conduit for introducing ground water into the apparatus,

wherein when the conduit is not present, the anode and cathode are configured to enable introduction of the anode and cathode into a groundwater source.

In a second aspect, the invention is directed to a method for reduction of contaminants in groundwater comprising:

(a) providing a metal iron anode and a high specific surface area cathode,

(b) placing the groundwater in electrical contact with the anode and cathode, and

(c) providing an electrical current between the anode and the cathode.

In some embodiments, the apparatuses, methods and processes decrease levels of contaminants such as, for example, halogenated organic compounds, in groundwater. The methods and processes comprise electrolysis incorporating an iron metal anode such as, for example, cast iron or mild steel anode, and high specific surface area cathode comprising, for example, metal, metallic foam material, porous material such as porous particulate composites or fiber composites. With iron anodes, dissolution of ferrous ions generated during the electrolysis process can create a strongly reducing electrolyte condition instead of an oxidizing condition that an inert anode, e.g., oxygen releasing anode, would generate. The reducing electroyte condition facilitates the cathodic reduction of, for example, halogenated organic compounds. With a high specific surface area cathode, halogenated organic contaminants and other reducible contaminants in groundwater can be quickly reducted to nontoxic or less toxic substances.

Typically, oxidation occurring at the inert anode produces oxidation reaction products such as O₂ or Cl₂, which results in increasing the oxidation-reduction potential (ORP) of electrolyte. Herein, methods are presented wherein the release of Fe²⁺ due to iron anode dissolution changes the environment to an electrolytically reducing environment, which is preferred for electrochemical reduction processes occurring at the cathode. In some embodiments, ferrous and ferric species generated from the anodic process also contribute to removal of contaminants.

The present disclosure can be utilized for remediation of groundwater contaminated with halogenated, e.g., chlorinated solvents. Previously dechlorination was achieved when anode and cathode were separated with ionic conductivity membrane or porous frit. A separated cell design prevents any impact from anodic reactions on reductive dechlorination and allows maintaining a reducing condition in cathodic reaction zone. However, for in situ remediation of fluids such as groundwater, separated cell design is not only complicated but also not cost-effective and causes higher energy consumption and maintenance problems. Herein, the inventors show that fast dehalogenation of halogenated compounds can be obtained in a reactor comprising an iron anode and high specific surface area cathode. This incorporates a unique anodic reaction on iron: ferrous species generated through iron anode dissolution, instead of oxygen gas formation on inert anode. A reducing environment for groundwater remediation can be realized, which helps to meet a variety of technical and economic challenges that electrochemical remediation method may face.

The apparatuses, methods and processes described herein impart significant advantages over former approaches. In some embodiments, the apparatuses, methods and processes herein provide fast, electrochemically reductive dehalogenation by creating a negative ORP electrolyte environment for cathodic reduction. In some embodiments, the rate of electrolytic reduction or dehalogenation can be controlled by increasing or decreasing the applied electric current. Expensive materials such as inert anodes or ion-exchange membranes are not required in the cell. Energy consumption by the cell is also less than that of methods using inert anodes because the iron dissolution potential is much lower than the water oxidation potential. The apparatuses, methods and processes herein are easily applied to on-site remediation of groundwater, using common materials and a power source. Environmental impact is also minimal, as environmentally benign iron is released into the aqueous environment. The apparatuses, methods and processes herein are also easily adapted for use in wells, cisterns, reservoirs, springs, rivers, lakes, porous environmental media or ex-situ remediation, and a non-homogenous mixture of contaminants can be treated simultaneously. Furthermore, due to the similarity of electrochemical reduction, the apparatuses, methods and processes can treat various contaminants such as, for example, halogenated organics (including solvents and dissolved solids), heavy metals and inorganic compounds.

Exemplary halogenated organics include tetrachloroethylene or perchloroethylene (PCE), trichloroethylene (TCE), and polychlorinated biphenyls (such as dioxin). Other exemplary halogenated organics are described in, for example, U.S. Pat. No. 5,102,510, hereby incorporated by reference in its entirety.

Exemplary heavy metals include chromium, arsenic, selenium and selenates.

Exemplary inorganic compounds include nitrates, perchlorates and sulfides.

The treatment or decontamination process is performed using an electrolytic cell in the presence of a solvent such as, for example, water or groundwater. The solvent further comprises at least one contaminant such as, for example, halogenated organics, heavy metals or inorganic compounds. In field applications, sufficient conductivity in groundwater is found due to naturally occurring ions such as, for example, sodium or calcium ions. Thus, the apparatuses, methods and processes herein may not require modification of the electrolyte solution prior to electrolysis. Instead, on-site parameters such as ionic conductivity of the groundwater and flow rate in the field can be used to modify the applied current accordingly to perform the reduction processes. In other embodiments, the composition and properties, e.g., ionic conductivity, of the groundwater can be adjusted by addition of suitable water soluble salts.

The apparatuses and methods may also be performed in either a single or separated cell. Thus, in some embodiments, the apparatus comprises a single cell. In some embodiments, the apparatus comprises a separated cell. In some embodiments, the method is conducted using a single cell. In some embodiments, the method is conducted using a separated cell.

In some embodiments, the methods and processes are applied to treatment of wastewater or groundwater. In some embodiments, the wastewater or groundwater is contaminated with more than one species of contaminant.

In some embodiments, the contaminants are selected from the group consisting of halogenated organic compounds, perchlorates, nitrates, chromium, and arsenic. In some embodiments, the contaminants are electrochemically reducible.

In some embodiments, the high specific surface area cathode comprises metallic foam. In some embodiments, the foam is a metal foam. In some embodiments, the foam or mesh type electrode is coated with a mixed metal oxide.

In some embodiments, the high specific surface area cathode comprises metallic foam selected from the group consisting of copper, iron, silver, titanium, and carbon. In some embodiments, the high specific surface area cathode comprises copper foam. In some embodiments, the high specific surface area cathode comprises iron foam. In some embodiments, the high specific surface area cathode comprises metallic foam selected from other electrically conductive materials.

In some embodiments, the high specific surface area cathode comprises metallic plate, mesh, sheet or rod. In some embodiments, the high specific surface area cathode comprises copper plate, sheet or rod. In some embodiments, the high specific surface area cathode comprises silver plate.

Anodes and cathodes can exist in various shapes, sizes and surfaces, depending on the particular configuration desired. In some embodiments, the anode comprises a solid. In some embodiments, the anode comprises mesh. In some embodiments, the anode comprises plates. In some embodiments, the anode comprises rods. The cathode can take on any size or geometry that provides adequate contact with the contaminated water and/or that is adapted to the remediation conditions. For example, the anode and cathode can be positioned ex situ either above the groundwater or above ground, and the apparatus may comprise a means of transporting the groundwater to the anode and cathode such as a pipe or series of pipes from the groundwater source to a cell containing the anode and cathode. The anode and cathode can also be positioned directly in the groundwater source to provide in situ remediation. In some embodiments, the anode and cathode are housed in a treatment unit disposed in a well comprising a pump directs groundwater into the treatment unit, and a seal prevents untreated water from exiting through the well to the ground or surrounding earth.

In some embodiments, the cathode comprises a solid. In some embodiments, the cathode comprises a porous structure. In some embodiments, the cathode comprises mesh. In some embodiments, the cathode is semipermeable.

High specific surface area cathodes exhibit high surface area to per unit mass or volume. In some embodiments, the specific surface area of the cathode is greater than about 100 m²/m³. In some embodiments, the specific surface area of the cathode is greater than about 400 m²/m³. In some embodiments, the specific surface area of the cathode is greater than about 500 m²/m³. In some embodiments, the specific surface area of the cathode is greater than about 600 m²/m³. In some embodiments, the specific surface area of the cathode is greater than about 700 m²/m³. In some embodiments, the specific surface area of the cathode is greater than about 800 m²/m³. In some embodiments, the specific surface area of the cathode is greater than about 900 m²/m³. In some embodiments, the specific surface area of the cathode is greater than about 1000 m²/m³. In some embodiments, the specific surface area of the cathode is greater than about 2000 m²/m³. In some embodiments, the specific surface area of the cathode is greater than about 3000 m²/m³. In some embodiments, the specific surface area of the cathode is greater than about 4000 m²/m³. In some embodiments, the specific surface area of the cathode is greater than about 5000 m²/m³.

In some embodiments, the specific surface area of the cathode is from about 100 m²/m³ to about 7000 m²/m³. In some embodiments, the specific surface area of the cathode is from about 400 m²/m³ to about 6500 m²/m³. In some embodiments, the specific surface area of the cathode is from about 500 m²/m³ to about 6500 m²/m³. In some embodiments, the specific surface area of the cathode is from about 1000 m²/m³ to about 6500 m²/m³. In some embodiments, the specific surface area of the cathode is from about 2000 m²/m³ to about 6500 m²/m³. In some embodiments, the specific surface area of the cathode is from about 3000 m²/m³ to about 6500 m²/m³. In some embodiments, the specific surface area of the cathode is from about 4000 m²/m³ to about 6500 m²/m³. In some embodiments, the specific surface area of the cathode is from about 4500 m²/m³ to about 5500 m²/m³. In some embodiments, the specific surface area of the cathode is about 5000 m²/m³.

Exemplary high specific surface area electrodes are identified in, for example, U.S. Pat. Nos. 5,680,292; 5,062,025; 5,079,674 and 4,327,400; each of which are incorporated here by reference in its entirety.

In some embodiments, the cathode has a mean pore size of at least about 100 μM. In some embodiments, the cathode has a mean pore size of greater than at least about 100 μM. In some embodiments, the cathode has a mean pore size of at least about 150 μM. In some embodiments, the cathode has a mean pore size of greater than at least about 150 μM. In some embodiments, the cathode has a mean pore size of at least about 200 μM. In some embodiments, the cathode has a mean pore size of greater than at least about 200 μM. In some embodiments, the cathode has a mean pore size of at least about 300 μM. In some embodiments, the cathode has a mean pore size of greater than at least about 300 μM.

In some embodiments, the cathode comprises at least about 85% metallic foam or metallic plate. In some embodiments, the cathode comprises at least about 90% metallic foam or metallic plate. In some embodiments, the cathode comprises at least about 95% metallic foam or metallic plate. In some embodiments, the cathode comprises at least about 99% metallic foam or metallic plate.

In some embodiments, the cathode comprises at least about 85% metallic foam. In some embodiments, the cathode comprises at least about 90% metallic foam. In some embodiments, the cathode comprises at least about 95% metallic foam. In some embodiments, the cathode comprises at least about 99% metallic foam.

In some embodiments, the cathode comprises at least about 85% metallic plate. In some embodiments, the cathode comprises at least about 90% metallic plate. In some embodiments, the cathode comprises at least about 95% metallic plate. In some embodiments, the cathode comprises at least about 99% metallic plate.

In some embodiments, the high specific surface area cathode imparts low cost with high electrocatalytic activity on aqueous dehalogenation.

In some embodiments the anode is iron. In some embodiments, the anode is cast iron, iron rod, iron plate or scrap iron. In some embodiments, the anode is cast iron.

In some embodiments, the anode comprises at least about 80% iron. In some embodiments, the anode comprises at least about 85% iron. In some embodiments, the anode comprises at least about 90% iron. In some embodiments, the anode comprises at least about 95% iron. In some embodiments, the anode comprises at least about 98% iron. The iron can be optionally doped with other metals.

The iron anode regulates the ORP of the groundwater. In contrast, previous methods incorporate an inert anode, which generates oxidative compositions such as, for example, elemental oxygen (O₂) and chlorine (Cl₂), leading in turn to oxidizing electrolyte conditions. The effect of electrolyte ORP condition on the reduction of halogenated organic compounds has not been considered in previous methods.

The released Fe²⁺ ions from the anode can serve as scavengers for oxidative compositions, such as dissolved oxygen, in water. Without competition from other oxidative compositions, contaminants such as halogenated organic compounds can be effectively reduced on the cathode. In some embodiments, dissolved oxygen in the electrolyte is less than about 10 mg/L when iron electrolysis is applied. In some embodiments, dissolved oxygen in the electrolyte is less than about 5 mg/L when iron electrolysis is applied. In some embodiments, dissolved oxygen in the electrolyte is less than about 2 mg/L when iron electrolysis is applied. In some embodiments, dissolved oxygen in the electrolyte is less than about 1 mg/L when iron electrolysis is applied.

The electrolyte can comprise ions typically found in groundwater such as, for example, sodium, calcium and the like. The groundwater may comprise ions such as, for example, lithium, sodium, potassium, calcium, magnesium, and the like. The groundwater may comprise salts of ions such as, for example, sodium bicarbonate or sodium sulfate. Thus, in some embodiments, the apparatuses and methods do not require modification of electrolyte solution in field applications, but rather can utilize the groundwater. For example, flow rate and conductivity of the groundwater in the field can be assessed and the applied current can be adjusted accordingly to obtain the desired process. These measurements and adjustments are well within the purview of the ordinarily skilled artisan.

In some embodiments, a soluble salt is included in the electrolyte. Exemplary electrolyte salts include salts of alkali metals such as lithium, sodium, potassium, rubidium, cesium, beryllium, magnesium, calcium, strontium and barium. Exemplary salts of alkali metals include halogen, perchlorate, bicarbonate, carbonate and sulfate salts. Exemplary salts further include amine salts such as tetraalkylammonium halides, perchlorates or tetrafluoroborates. In some embodiments, the salt is sodium bicarbonate, sodium carbonate, sodium halide (such as sodium chloride or iodide), sodium sulfate, potassium bicarbonate, potassium carbonate, potassium halide (such as potassium chloride or iodide), potassium sulfate, magnesium carbonate, magnesium sulfate, calcium carbonate or calcium sulfate. In some embodiments, the salt is sodium bicarbonate, sodium sulfate, potassium bicarbonate, potassium sulfate, magnesium carbonate, magnesium sulfate, calcium carbonate or calcium sulfate. In some embodiments, the salt is sodium bicarbonate or sodium sulfate. In some embodiments, the salt is sodium bicarbonate. In some embodiments, the salt is sodium sulfate. In some embodiments, the electrolyte concentration is at least about 0.002 mol L⁻¹. In some embodiments, the electrolyte concentration is at least about 0.01 mol L⁻¹. In some embodiments, the electrolyte concentration is at least about 0.02 mol L⁻¹. In some embodiments, the electrolyte concentration is at least about 0.03 mol L⁻¹. In some embodiments, the electrolyte concentration is at least about 0.035 mol L⁻¹. In some embodiments, the electrolyte concentration is at least about 0.04 mol L⁻¹.

In some embodiments, the electrolyte concentration is from about 0.01 mol L⁻¹ to about 0.05 mol L⁻¹. In some embodiments, the electrolyte concentration is from about 0.02 mol L⁻¹ to about 0.05 mol L⁻¹. In some embodiments, the electrolyte concentration is from about 0.02 mol L⁻¹ to about 0.04 mol L⁻¹. In some embodiments, the electrolyte concentration is from about 0.03 mol L⁻¹ to about 0.05 mol L⁻¹. In some embodiments, the electrolyte concentration is from about 0.03 mol L⁻¹ to about 0.05 mol L⁻¹. In some embodiments, the electrolyte concentration is from about 0.03 mol L⁻¹ to about 0.04 mol L⁻¹. In some embodiments, the electrolyte concentration is from about 0.04 mol L⁻¹ to about 0.05 mol L⁻¹.

In some embodiments, the final elimination efficiency is greater than about 75%. In some embodiments, the final elimination efficiency is greater than about 80%. In some embodiments, the final elimination efficiency is greater than about 85%. In some embodiments, the final elimination efficiency is greater than about 90%. In some embodiments, the final elimination efficiency is greater than about 92%. In some embodiments, the final elimination efficiency is greater than about 93%. In some embodiments, the final elimination efficiency is greater than about 94%. In some embodiments, the final elimination efficiency is greater than about 95%. In some embodiments, the final elimination efficiency is greater than about 96%. In some embodiments, the final elimination efficiency is greater than about 97%. In some embodiments, the final elimination efficiency is greater than about 98%.

The final transformation efficiency (FTE) and final degradation efficiency (FDE) are calculated using the same equation. Thus, either can be used as terms for degradation or transformation of the contaminant. In some embodiments, the FTE is greater than about 40%. In some embodiments, the FTE is greater than about 50%. In some embodiments, the FTE is greater than about 55%. In some embodiments, the FTE is greater than about 60%. In some embodiments, the FTE is greater than about 65%. In some embodiments, the FTE is greater than about 70%. In some embodiments, the FTE is greater than about 75%. In some embodiments, the FTE is greater than about 80%. In some embodiments, the FTE is greater than about 85%. In some embodiments, the FTE is greater than about 90%. In some embodiments, the FTE is greater than about 92%. In some embodiments, the FTE is greater than about 93%. In some embodiments, the FTE is greater than about 94%. In some embodiments, the FTE is greater than about 95%. In some embodiments, the FTE is greater than about 96%. In some embodiments, the FTE is greater than about 97%. In some embodiments, the FTE is greater than about 98%. In some embodiments, the FTE is greater than about 99%.

In some embodiments, the current is from about 5 mA to about 120 mA. In some embodiments, the current is from about 5 mA to about 90 mA. In some embodiments, the current is from about 5 mA to about 50 mA. In some embodiments, the current is from about 5 mA to about 40 mA. In some embodiments, the current is from about 5 mA to about 30 mA. In some embodiments, the current is from about 10 mA to about 120 mA. In some embodiments, the current is from about 10 mA to about 90 mA. In some embodiments, the current is from about 20 mA to about 120 mA. In some embodiments, the current is from about 20 mA to about 90 mA. In some embodiments, the current is from about 30 mA to about 90 mA.

The power supply can be any source known in the art including, for example, DC, wind energy, hydroelectric energy, and solar power. In some embodiments, solar energy panels are connected to electrodes, and are sufficient to deliver the requisite energy to induce the transformation in groundwater. In some embodiments, the power supply is solar, DC, or AC. In some embodiments, the power supply is solar or DC. In some embodiments, the power supply is reversed polarity.

The present invention can be operated in several different modes, including, for example batch, circulation and continuous modes. In batch mode, a treatment unit is filled with contaminated fluid and treated electrolytically until the desired level of decontamination is achieved. In circulation mode, contaminated fluid is circulated through the electrolytic cell and discharged after treatment.

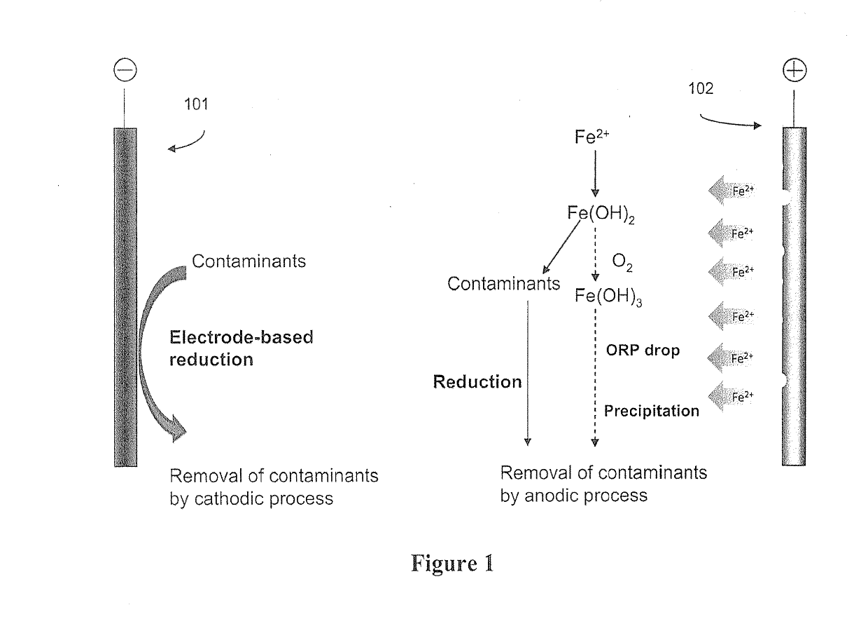

An exemplary embodiment of the apparatus, methods and processes of the invention is shown in FIG. 1. The apparatus comprises a foam cathode (101) and an iron anode (102). At the anode, iron is oxidized to Fe²⁺, which in turn can combine to form ferrous species such as, for example ferrous hydroxide, ferrous carbonate or other ferrous complexes. At the cathode(101), contaminants are reduced to less noxious species (for example, halogenated organics are reduced to non-halogenated organics).

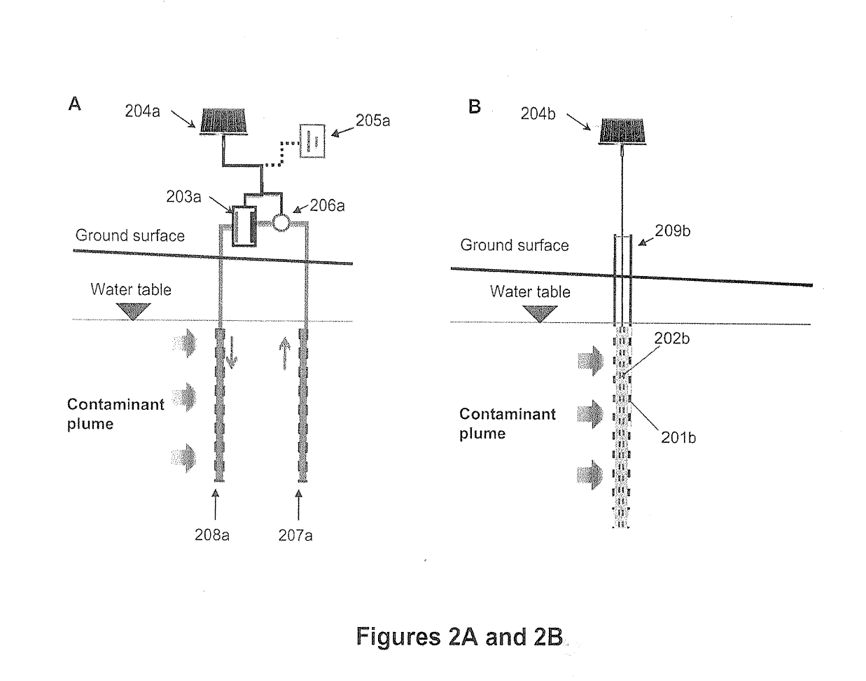

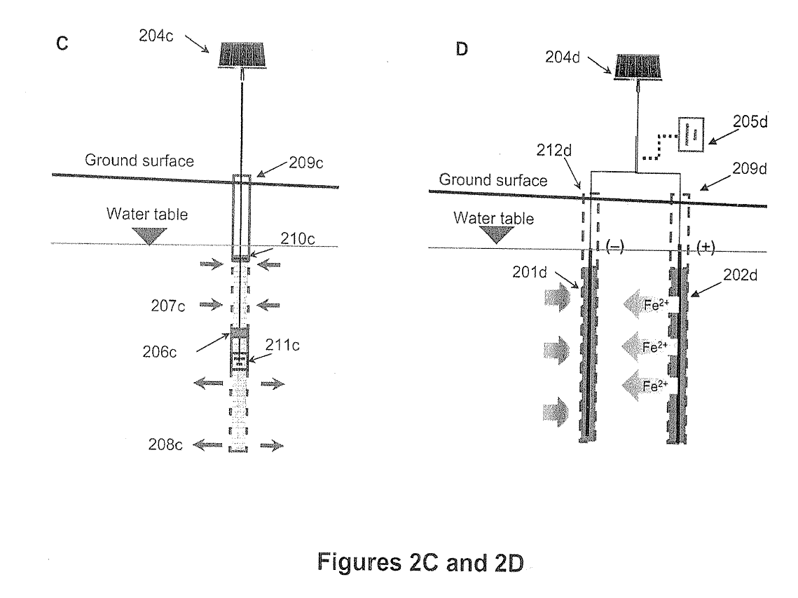

The methods and processes of the invention can be conducted according to different strategies. The apparatus of the invention can also comprise various configurations. In some embodiments, the apparatus and/or method comprises on site application comprising a pump and a customized electrolytic cell comprising the anode and cathode of the invention. In some embodiments, the apparatus and/or method comprises ex-situ treatment at sites and contaminated aquifers (or other water source). In some embodiments, the apparatus and/or method comprises in situ treatment at sites and contaminated aquifers (or other water source). In some embodiments, the apparatus and/or method comprises the use of solar panels as energy sources. In some embodiments, electrodes can be inserted in a well or well arrangement in aquifers, wherein the electrodes are further connected to a power source such as, for example, a battery or solar panel. The apparatus and/or methods are thus not limited to a particular arrangement, as those of ordinary skill in the art will recognize various configurations and methods that can be used at contaminated sites. Exemplary methods and apparatus arrangements for contaminated sites are shown in FIG. 2. FIG. 2A shows ex-situ treatment comprising an electrolytic cell (203a) comprising the anode and cathode of the invention. Power sources may be either solar (204a) or DC current (205a). A pump (206a) provides contaminated groundwater (207a) to the electrolytic cell. Following treatment, the treated groundwater is then returned to the underground source via a discharge (208a). FIG. 2B shows the electrolytic cell comprising a porous cathode (201b) and mesh anode (202b) located within the well (209b) beneath the water table, with a solar power source (204b). The mesh anode and porous cathode are then used to treat the contaminant plume from the ground water, wherein mixing and treatment occur by groundwater flow. FIG. 2C shows circulation (single for tandem) wells (209c) with the electrolytic cell or treatment unit (211c) powered via a solar panel (204c) is located within the well (209c), wherein groundwater is pumped (206c) into the treatment unit (207c) and treated water is discharged(208c). A cap or seal (210c) prevents water from exiting to the ground surface. FIG. 2D shows injection of electrolysis products by ion migration or other movements under an electrical field. In this embodiment, the cathode (201d) and anode (202d) are located in separate wells (212d and 209d), respectively). The power source may be solar (204d) or DC power (205d).

It will recognized that one or more features of any embodiments or aspects disclosed herein can be combined and/or rearranged within the scope of the invention to produce further embodiments that are also within the scope of the invention.

As will be apparent to one of ordinary skill in the art from a reading of this disclosure, the embodiments of the present disclosure can be embodied in forms other than those specifically disclosed above. The particular embodiments described herein are, therefore, to be considered as illustrative and not restrictive. Those skilled in the art will recognize, or be able to ascertain, using no more than routine experimentation, numerous equivalents to the specific embodiments described herein. The scope of the invention is as set forth in the appended claims and equivalents thereof, rather than being limited to the examples contained in the foregoing description.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

### Redox Control for Electrochemical Dechlorination of Trichloroethylene in Bicarbonate Aqueous Media

Materials. The chemicals used include TCE (99.5%, Sigma-Aldrich), cis-dichloroethylene (cis-DCE, 97%, Sigma-Aldrich),vinyl chloride (VC, analytical standard, 200 μg mL⁻¹ in methanol, Supelco), hydrocarbon gas standard (analytical standard, 1%(w/w) methane, ethene, acetylene in nitrogen, Supelco), and NaHCO₃ (analytic grade, J T Baker). Excess TCE was dissolved into 18 MΩ high-purity water to form a TCE saturated solution (20° C., saturated solubility is 1.07 mg mL⁻¹), which was used as stock solution for preparing TCE aqueous solutions. The conductive materials investigated as cathode include copper foam (60 pores per inch (PPI), 99.5% purity, Aibixi Ltd., China), iron foam (45 PPI, 98% iron and 2% nickel, Aibixi Ltd., China), nickel foam (60 PPI, 99.9% purity, Lyrun Ltd., China), and vitreous carbon foam (100 PPI, ERG, USA). The materials were cut into the same size with a working geometry of 4 cm length, 1 cm width, and 0.3 cm thickness. Copper plate (99.9% purity, VWR) and high-purity iron plate (3N5 purity, ESPI metals, USA) electrodes (4 cm length, 1 cm width, 0.1 cm thickness) were also investigated as cathode materials. Three anode materials were compared in this study: cast gray iron (Macmaster-Carr, USA), mixed metal oxide (MMO, mesh type, 3N International, USA), and lead dioxide. The lead dioxide electrode was fabricated in the laboratory using electrodeposition method (40 mA cm⁻² current density) as described Mao et al., Russ. J. Electrochem. 2008, 44(7), 802-811; herein incorporated by reference in its entirety. Before each experiment, the iron electrode was polished with coarse emery cloth, etched by diluted HCl solution (10 wt %), and washed with distilled water. The copper foam electrode was also rinsed with diluted H₂SO₄ solution (3 wt %), 2% Micro-90 cleaning solution (Cole Parmer, USA), and distilled water prior to assembly.

Analytical Methods. Concentrations of TCE, cis-DCE, and VC were measured using 8610GC instrument with purge-trap system (SRI, USA), photoionization detector, and MXT-VOL stationary column. The purge-trap autosampler was equipped with carbon-sieve trap and Tenax trap, allowing the detection of highly volatile VC. 50 μL of water sample was injected in 5 mL of deionized water in glass tubes and loaded into the 10-port autosampler. The GC was programmed at 40° C. for 6 min, then ramped to 60° C. in 2 min, and held at 60° C. for 10 min. Hydrocarbon gases (methane, ethene, ethane, and acetylene) in the headspace of an electrolytic cell were analyzed through a Model 310 GC (SRI, USA) with flame ionization detector and Haysep-T column. 100 μL of headspace gas was sampled and injected from an on-column port. The temperature program applied was as follows: heat column from 40 to 140° C. at a rate of 15° C. min⁻¹, hold 140° C. for 1 min, and cool to 40° C. at a rate of 20° C. min⁻¹. Chloride ion concentration was analyzed by Dionex DX-120 ion chromatograph. After each experiment, an aliquot 0.2 to 0.5 mL of supernatant was transferred into 5 mL vials which had been prefilled with deionized water (>18 MΩ), and then filtered by 0.45 μm pore size filter paper prior to final analysis. pH, conductivity, and oxidation-reduction potential (ORP) of the electrolyte were measured by pH meter, conductivity meter, and ORP meter with corresponding microprobes (Microelectro, USA). The microprobes allow the measurement on these parameters using a small amount of liquid (≈0.2 mL).

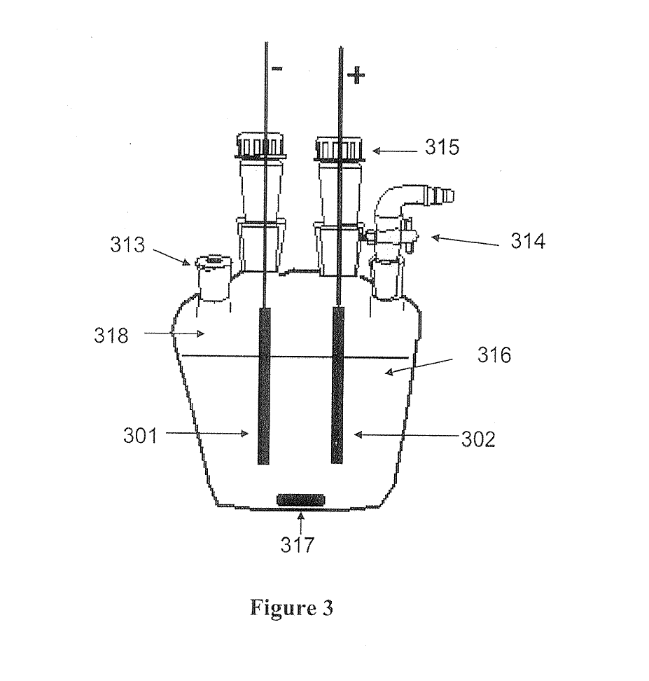

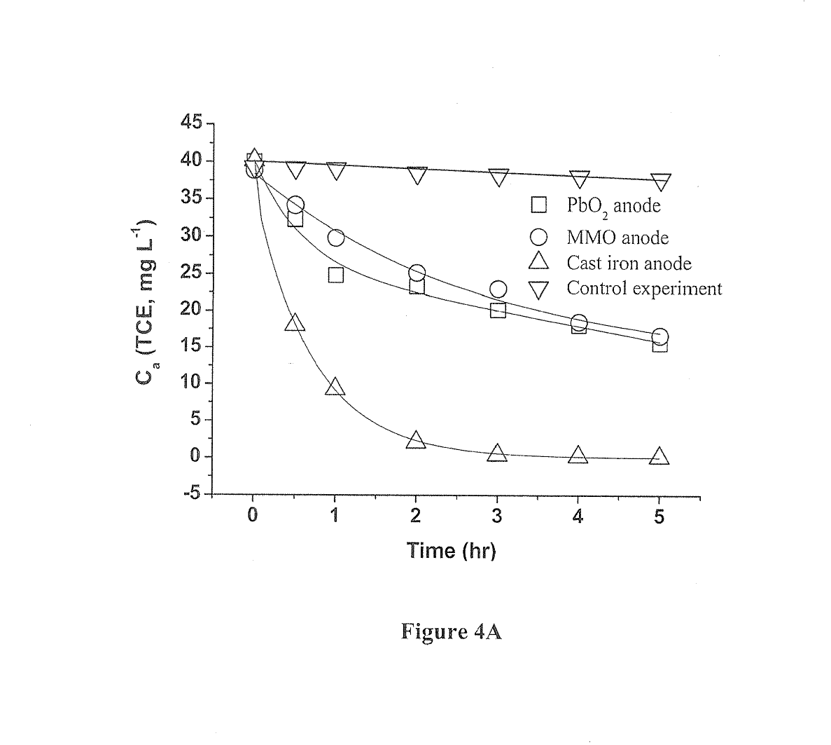

Procedure. The electrochemical transformation experiments were conducted in an undivided glass electrolytic cell (FIG. 3) at ambient temperature (25±1° C.). The cell was fitted with a sampling port (313), a stopcock adapter (314) for connection to an expandable syringe and gas-tight adapters (315). All adapters were sealed with vaccum grease and fixed with tape and clamps. The temperature variation of the electrolyte during electrolysis is less than 2.6° C. for all experiments. A 150 mL syringe was connected to the cell, allowing gas expansion during electrolysis when the inside pressure is above 2 kg force cm⁻² (no gas expansion was observed under this pressure in all experiments). The cathode (301) and anode (302) were placed in parallel position with 1.7 cm distance. During electrolysis, the electrolyte (316) was stirred using a Teflon-coated, one inch magnetic stirring bar (317) (500 rpm). For each trial, 110 mL of 0.01M sodium bicarbonate solution was transferred into the cell, and 5 mL of TCE saturated water solution was added. The solution was stirred for 30 min to allow equilibrium of TCE in the aqueous solution. The electric current was then applied, and TCE concentration was routinely measured. The aqueous solution was also sampled for ORP measurements (sample volume was 0.2 mL). For the headspace gas (318) (initial headspace above solution was 67 mL), gas sampling (100 μL) was done in some experiments. After electrolysis, the final pH and conductivity of the solution were measured.

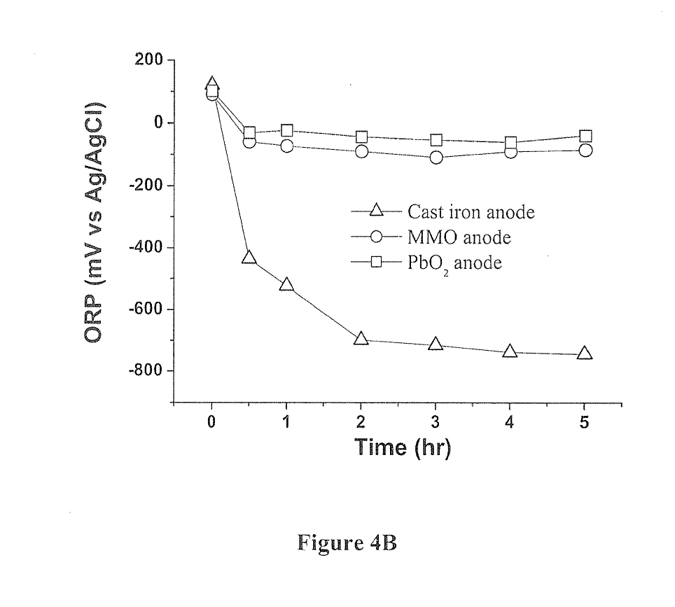

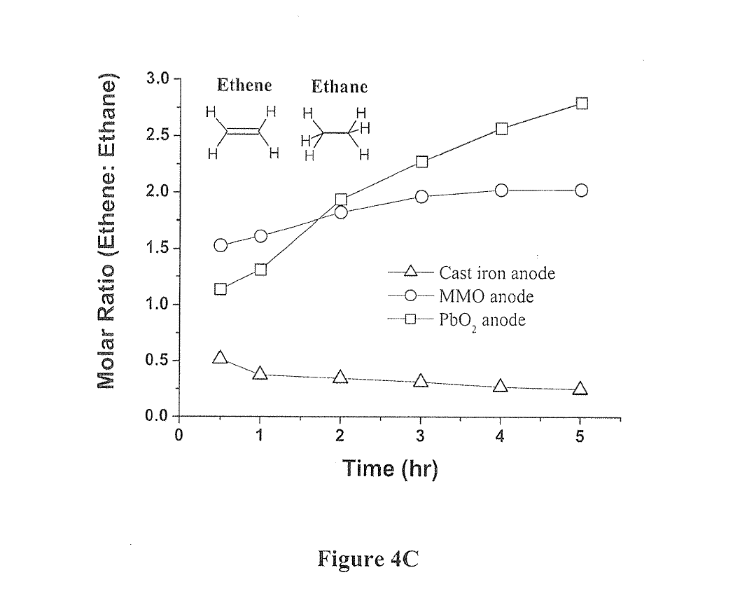

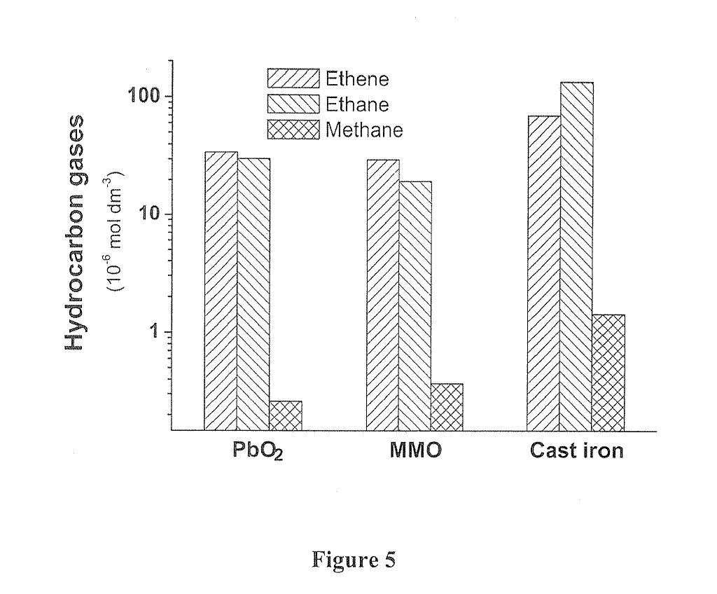

The effects of three types of anodes MMO, PbO₂, and cast iron, on TCE transformation by constant current electrolysis in a mixed-electrolyte cell were compared. The decay of aqueous TCE in the cells using copper foam cathode and these anodes is presented in FIG. 4A. Cast iron anodes caused faster and sustainable transformation of aqueous TCE compared to other anodes. Within 0.5 h, the aqueous TCE concentration decreased by 50%, and after 5 h the concentration decreased to below detection limits of the analytic method used in this study (0.1 mg L⁻¹). In contrast, the concentrations of aqueous TCE when PbO₂ and MMO anodes are used decreased to 15.6 and 16.6 mg L⁻¹, respectively, after 5 h. PbO₂, as a high OER overpotential anode, did not show considerable improvement in TCE degradation, suggesting that the effect of oxidation pathway on the anode surface is limited. During the electrolysis, cis-DCE and VC, as possible degradation intermediates of TCE, were monitored. However, no visible accumulation of these chlorinated intermediates was found in three cells. On the other hand, hydrocarbon gases (ethene, ethane and methane) were detected immediately after electrolysis started. Hydrocarbon gas concentrations in the headspaces after 0.5 h were also measured (FIG. 5). The much higher concentrations of ethene, ethane, and methane in the cell using cast iron anode indicate that faster TCE degradation occurred in this cell.

The anodic reaction with cast iron causes the oxidation of iron since the standard potential of Fe⁰—Fe²⁺ redox couple is only −0.44 V vs SHE (Eq 1) (See, Sengil, I. A et al. J. Hazard. Mater. 2006, 137 (2), 1197-1205 and Bard, A. J.; Faulkner, L. R. Electrochemical Methods: Fundamentals and Applications, 2nd ed.; John Wiley & Sons: New York, 2001; each hereby incorporated herein by reference in its entirety). Ferrous ions generated from the iron anode could combine with the hydroxyls, forming amorphous ferrous hydroxide (Eq 2).

Fe-2e=Fe²⁺ (Eq. 1)

Fe²⁺+2OH⁻═Fe(OH)₂↓ (Eq. 2)

To understand the enhancing effect from cast iron anode, the electrolyte ORP was monitored during electrolysis, and their profiles are shown in FIG. 4B. The ORP of the electrolyte in the cell using cast iron anode decreased sharply within 0.5 h followed by a progressively stable ORP value around −800 mV. In contrast, the other anodes showed a much higher ORP value (between 0 and −100 mV), indicating a less reducing environment in the electrolyte compared to the iron anode. Because the primary reaction at the iron anode is formation of ferrous ions, rather than the oxygen evolution, the subsequently formed ferrous species (ferrous hydroxide, ferrous carbonate, ferrous complexes, etc.) have reduction potential to consume the oxidative substances in the electrolyte, such as dissolved oxygen, creating a very reducing mixed electrolyte. Thus, except for the chemical recombination through Eq 4, the atomic hydrogens (Eq 3) at the cathode mostly contribute to the reduction of TCE (Eq 5), and a faster degradation rate is achieved (Li, T.; Farrell, J. Environ. Sci. Technol. 2001, 35 (17), 3560-3565; herein incorporated by reference in its entirety). In the cells with inert anode (MMO or PbO₂), oxygen gas is continuously generated at the anode which possibly limits the TCE transformation. Furthermore, the reduction potential of O₂ is 1.229 V vs SHE (Eq 6) (Bard, A. J.; Faulkner, L. R. Electrochemical Methods: Fundamentals and Applications, 2nd ed.; John Wiley & Sons: New York, 2001; herein incorporated by reference in its entirety), higher than the reduction potential of TCE (0.42 V vs SHE from TCE to cis-DCE) (Wiedemeier, T. H.; Rifai, H. S.; Newell, C. J.; Wilson, J. T. Natural attenuation of fuels and chlorinated solvents in the subsurface, 1^{st} ed.; John Wiley and Sons: New York, USA, 1999; herein incorporated by reference in its entirety), and O₂ is much more vulnerable to reduction than TCE (Mao et al. Environmental Science & Technology 2011, 45(15), 6517-6523; herein incorporated by reference in its entirety). As a result, very different TCE transformation behavior under 90 mA and even lower electrolysis current (e.g., 30 mA) is observed in these cells.

H₂O+e=H.+OH⁻ (Atomic hydrogen formation) (Eq 3)

H.+H.=H₂↑ (Hydrogen evolution) (Eq 4)

2H.+RCl=RH+H⁺+Cl⁻ (Hydrodechlorination) (Eq 5)

O₂+4H⁺4e=2H₂O (Oxygen reduction) (Eq 6)

The findings can be further verified by comparing the degradation products in the three cells. The molar ratios of ethane (with four hydrogen atoms in the molecular structure) to ethane (with six hydrogen atoms in the molecular structure) in the headspace gas during electrolysis are compared in FIG. 4C. Less ethene was generated, with an ethene to ethane ratio of less than 1, in the cell using iron anode. However, the cells using inert anodes behave very differently with higher ratios of ethene to ethane. Under similar mass transfer and electrolysis conditions, less ethane production means atomic hydrogen is less efficient for TCE reduction, suggesting that some of the atomic hydrogens have been consumed by other reactions or processes.

Effect of Cathode Type. Four foam materials and two planar materials are compared as cathode for electrochemically reductive dechlorination of TCE with cast iron anode. A current of 90 mA was used for all electrolysis experiments. Under this current, gas bubbles generation on electrodes confirmed that all the cathodes worked at a hydrogen-releasing potential. Based on the exponential decay of TCE when iron anode and copper cathode were used (FIG. 4A), a pseudofirst-order model is proposed to describe the transformation kinetics of TCE (model development is given in Environ. Sci. Technol. 2011, 45, 6517-6523; herein incorporated by reference in its entirety)

$$ln \frac{ {C}_{a ( t )}}{{C}_{a ( 0 )}} = - \frac{k + g {H}_{TCE}}{{V}_{a} + {V}_{h} {H}_{TCE}} t \qquad ( Eq 7 )$$

where Cₐ₍₀₎ and Cₐ₍ₜ₎ are TCE concentration in aqueous solution at time=0 and time=t (mg L⁻¹), respectively; Vₐ is the volume of aqueous solution (L); Vₕ is the volume of headspace (dm³); k is the first-order rate constant of TCE degradation by electrochemical process (L h⁻¹); g is the headspace gas expansion rate (dm³ h⁻¹); H_{TCE} is the dimensionless Henry law constant of TCE; and t is the electrolysis time (hour). Assuming g=0, which is valid based on the results, Eq 7 could be further represented as Eq 8.

$$ln \frac{{C}_{a ( t )}}{{C}_{a ( 0 )}} = - \frac{kt}{{V}_{a} + {V}_{h} {H}_{TCE}} \qquad ( Eq 8 )$$

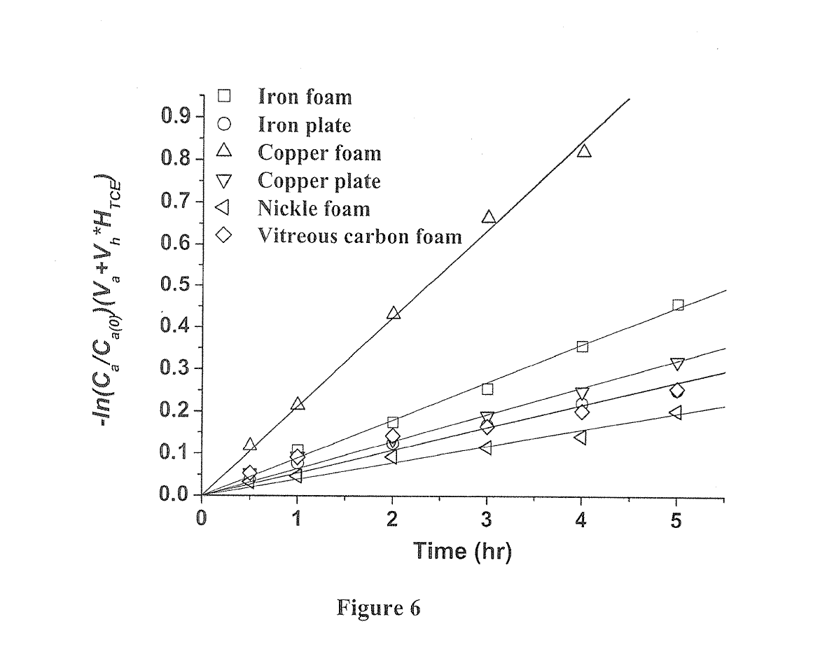

Plots of −ln(Cₐ₍ₜ₎/Cₐ₍ₜ₎)(Vₐ+VₕH_{TCE}) versus time for different cathodes are presented in FIG. 6, and the corresponding k values are listed in Table 1. The copper foam cathode, followed by iron foam and copper plate, exhibits the best performance for transformation of TCE with iron anodes. Even with high specific surface area, the vitreous carbon and nickel foam cathode did not result in high dechlorination rates, being less effective than copper plate cathode, but comparable to iron plate cathode. Relatively little information is available about the electrocatalytic reactions of TCE on different cathodes. No specific influence for the electrode materials (carbon, copper, and lead) was reported on the electrochemical degradation of PCE (Saez, V. et al. J. New Mater. Electrochem. Syst. 2008, 11 (4), 287-295; herein incorporated by reference in its entirety). Hydrogenation efficiencies close to 100% were reported for Ag, Zn, Cu, and Pb cathodes in studies on electroreduction of chloroform (Sonoyama, N. et al. Chem. Lett. 1997, 2, 131-132; herein incorporated by reference in its entirety). The present results with an iron anode show that although there is no difference in transformation speciation, TCE transformation rate in the presence of iron anodes is also dependent on the type of cathode material. Moreover, the transformation rate could be further improved by adopting high specific surface area electrodes. Copper and iron foams both show better performance than that of the corresponding plate material. The vitreous carbon foam did not show superior performance, which is in agreement with other investigators' results on aqueous dechlorination (Saez, V. et al. Ind. Eng. Chem. Res. 2010, 49 (9), 4123-4131; herein incorporated by reference in its entirety).

TABLE 1
Experimental results for the batch electrolysis experiments with different anodes and cathodes
(current = 90 mA)

| | | | | | | | | | C mass | |
|---|---|---|---|---|---|---|---|---|---|---|
| | | | | | | | | | recovery | |
| | | | Cₐ | ζ | | | Cl⁻ mass | | (%) | k |
| | | | (mg L⁻¹) | (μS cm⁻¹) | pH | Chloride | recovery | FDE^{a} | (0.5 h- | (×10⁻³ L |
| N | Cathode | Anode | (ini-fin) | (ini-fin) | (ini-fin) | (mg L⁻¹) | (%) | (%) | fin)^{b} | h⁻¹) |
| 1 | Copper | Cast | 39.9-<0.1 | 862-1368 | 7.7-11.3 | 32.7 | 80.2 | >99.7^{c} | 90-25 | 212.5 ± 3.8 |
| | foam | iron | | | | | | | | |
| 2 | Copper | MMO | 38.9-16.7 | 853-840 | 7.7-7.1 | 16.2 | 89.2 | 57.2 | 102-70 | NA |
| | foam | | | | | | | | | |
| 3 | Copper | PbO₂ | 40.0-16.5 | 853-911 | 7.6-6.9 | 11.7 | 74.3 | 61.0 | 104-71 | NA |
| | foam | | | | | | | | | |
| 4 | Copper | Cast | 38.6-4.3 | 845-970 | 7.6-10.1 | 30.5 | 80.3 | 88.8 | 90-23 | 64.6 ± 2.2 |
| | plate | iron | | | | | | | | |
| 5 | Pure iron | Cast | 39.7-7.1 | 850-866 | 7.5-9.7 | 19.6 | 72.1 | 82.1 | 89-33 | 54.4 ± 2.2 |
| | plate | iron | | | | | | | | |
| 6 | Iron foam | Cast | 40.2-1.7 | 863-950 | 7.7-10.1 | 19.5 | 57.7 | 95.6 | 94-20 | 90.1 ± 1.6 |
| | | iron | | | | | | | | |
| 7 | Nickle | Cast | 40.3-10.1 | 854-858 | 7.7-9.5 | 13.2 | 63.2 | 74.9 | 91-36 | 39.5 ± 1.6 |
| | foam | iron | | | | | | | | |
| 8 | Vitreous | Cast | 40.4-7.1 | 855-1393 | 7.6-11.8 | 22.8 | 80.6 | 82.4 | 86-30 | 54.1 ± 3.7 |
| | carbon | iron | | | | | | | | |
| | foam | | | | | | | | | |

^{a}FDE(Final degradation Efficiency) = (Cₐ₍₀₎ − Cₐ₍₅ₕ₎/Cₐ₍₀₎) × 100%
^{b}Carbon mass recovery only considered the carbon mass contribution from the spiked TCE.
^{c}>99.7% means the concentration of aqueous TCE was below the detection limitation of the analytic method (0.1 mg L⁻¹) after 5-hours electrolysis. 0.1 mg L⁻¹ was used as final TCE concentration for FDE calculation. Same for other silimar expressions in this table.

A summary of other information is presented in Table 1. A considerable pH rise is observed in all the experiments using iron anode. When inert anode is used, the protons generated from anode neutralize the hydroxyl ions generated from cathode, maintaining a relatively neutral pH. However, when iron anode is used, hydroxyl ions produced by cathodic reactions will not completely combine with ferrous ions to form precipitate (Kₛₚ of Fe(OH)₂ is 7.08×10⁻¹⁶; Cornell, R. M.; Schwertmann, U. The Iron Oxides: Structure, Properties, Reactions, Occurrences and Uses, 2nd ed.; Wiley-VCH: Weinheim, Germany, 2003; herein incorporated by reference in its entirety), promoting the pH to increase. In addition, other chemical processes such as the formation of FeCO₃(s), Fe(HCO₃)⁺ could consume some ferrous ions and further improve the concentration of free hydroxyl ions (Langmuir, D. Aqueous Environmental Geochemistry; Prentice Hall: Upper Saddle River, N.J., USA, 1997; and Roh, Y. et al, Environ. Geol. 2000, 40 (1-2), 184-194; each herein incorporated by reference in its entirety). Although alkaline electrolyte is not preferred for electrochemical reductive dechlorination (Al-Abed, S. R. et al. Chemosphere 2006, 64 (3), 462-469; herein incorporated by reference in its entirety), the pH is a less important factor as compared to ORP and electrode type since the neutral pH did not bring high dechlorination rate in this study (in the cell using inert anodes). As for the chloride ions, higher final concentrations were detected in the experiments with high TCE removal rates, which is in agreement with expectations. However, comparing chloride ions mass recovery shows relatively lower rates (57.7%) when iron anode is used. These low values may be in part explained by absorption on ferrous hydroxide and formation of ferrous and ferric chloride complexes in solution (Cornell, R. M.; Schwertmann, U. The Iron Oxides: Structure, Properties, Reactions, Occurrences and Uses, 2nd ed.; Wiley-VCH: Weinheim, Germany, 2003; Langmuir, D. Aqueous Environmental Geochemistry; Prentice Hall: Upper Saddle River, N.J., USA, 1997; Roh, Y. et al. Environ. Geol. 2000, 40 (1-2), 184-194; each herein incorporated by reference in its entirety). Additionally, relatively good carbon mass recovery rates are obtained 0.5 h after electrolysis. However, carbon mass recovery rates decrease after 5 h of testing, especially when iron anodes were used (20% to 36%). In the literature, carbon mass recovery varied from around 30% to above 90% when TCE and PCE bulk electrolysis were conducted in a closed system similar to the setup used in this study (Al-Abed, S. R. et al. Environ. Eng. Sci. 2007, 24 (6), 842-851; Saez, V. et al. Water Res. 2009, 43 (8), 2169-2178; Chen, G. et al. J. Appl. Electrochem. 2003, 33 (2), 161-169; each herein incorporated by reference in its entirety). It is possible that the relatively low carbon mass recoveries after 5 h are due to the buildup of gas pressure in the headspace, which could produce variable measurements in the absolute concentration of hydrocarbons gas in headspace gas. However, using the ratio of these hydrocarbon gases as an index to analyze the degradation behavior of TCE is more reliable since ethane and ethene have similar physiochemical properties.

Effect of Current and Initial TCE Concentration. For a specific electrochemical system, current, and substrate concentration are two variables that could impact the process. Six levels of current and three levels of initial TCE concentration are investigated. The results, including final degradation efficiency (FDE) and k values, are summarized in Table 2.

TABLE 2
Pseudofirst-order rate constant (k) and FDE under different currents and initial
concentrations^{a}

| | Cₐ₍₀₎ ≈20 mg L⁻¹ | | Cₐ₍₀₎ ≈39 mg L⁻¹ | | Cₐ₍₀₎≈74 mg L⁻¹ | |
|---|---|---|---|---|---|---|
| Current | k | FDE | k | | k | FDE |
| (mA) | (×10⁻³ L h⁻¹) | (%) | (×10⁻³ L h⁻¹) | FDE (%) | (×10⁻³ L h⁻¹) | (%) |
| 5 | 51.55 ± 6.03 | 65.9 | 19.39 ± 1.67 | 42.2 | 18.98 ± 1.92 | 38.7 |
| 10 | 57.51 ± 1.25 | 83.9 | 39.81 ± 3.13 | 72.1 | 45.58 ± 1.33 | 76.5 |
| 20 | 116.5 ± 4.06 | 98.0 | 113.8 ± 11.49 | 99.2 | 64.45 ± 3.62 | 84.6 |
| 30 | 150.12 ± 2.7 | >99.4^{b} | 149.33 ± 2.96 | >99.7 | 105.18 ± 1.89 | 96.7 |
| 60 | 241.4 ± 6.49 | >99.4 | 128.24 ± 4.67 | >99.7 | 150.05 ± 5.13 | 99.2 |
| 90 | 287.6 ± 9.58 | >99.4 | 212.51 ± 3.81 | >99.7 | 245.15 ± 7.23 | >99.8 |

^{a}20 mg L⁻¹, 39 mg L⁻¹ and 74 mg L⁻¹ initial concentration of TCE were prepared by spiking 2.5 mL, 5 mL and 10 mL TCE saturated solution in 112.5 mL, 110 mL, 105 mL 0.01 mol L⁻¹ NaHCO₃, respectively. The exact concentration of TCE in each trial was measured before electrolysis was started.
^{b}>99.4% means the concentration of aqueous TCE was below the detection limitation of the analytic method (0.1 mg L⁻¹) after 5-hours electrolysis. 0.1 mg L⁻¹ was used as final TCE concentration for FDE calculation. Same for other silimar expressions in this table.

As presented in Table 2, FDE of TCE (measured after 5 h of electrolysis) increases to more than 99% with increasing the electric current at three levels of initial concentration. As the initial concentration increases, it becomes relatively harder to achieve more than 99% TCE transformation after 5 h electrolysis. For the pseudofirst-order rate constant (k, L h⁻¹), the first observation is that it increases with increasing the applied current. This trend appears clear for the case of 74 mg L⁻¹. The second observation is that rate constant k is dependent on TCE concentration and current (or current density), but does not follow a consistent trend with concentration and current. For the electrochemical dechlorination of TCE on iron electrodes, the reaction rate (r_{TCE}) is believed to be associated with adsorbed hydrogen and adsorbed TCE, as given by

r_{TCE}=k_{TCE}Θ_{H}ⁿΘ_{TCE} (Eq 9)

where Θ_{H} and Θ_{TCE} represent the surface coverage of adsorbed hydrogen (or atomic hydrogen) and adsorbed TCE, respectively, and n is the reaction order of hydrogen in the hydrodechlorination reaction (Li, T. et al. Environ. Sci. Technol. 2001, 35 (17), 3560-3565; herein incorporated by reference in its entirety). Assuming the reduction of TCE on copper proceeds with the same mechanism, the change in k can be explained. When the current density increases, more atomic hydrogens cover the real surface of cathode, so the absorbed TCE molecules are more likely to acquire atomic hydrogens. This explains the trend that k increases with increasing current. Other investigators also reported faster TCE reduction rates at more negative cathode potentials (Chen, G. et al. J. Appl. Electrochem. 2003, 33 (2), 161-169; herein incorporated by reference in its entirety). Their results also can be explained by the effect of Θ_{H}. On the other hand, increasing TCE concentration has an adverse effect on k values, suggesting that the TCE coverage is not proportional to the concentration of TCE in the bulk electrolyte. The reduction of TCE on the cathode proceeds with a chemisorption process, rather than a physical adsorption process, and the chemisorption process is the controlling process for the overall rate of dechlorination (Li, T. et al. Environ. Sci. Technol. 2001, 35 (17), 3560-3565; herein incorporated by reference in its entirety).

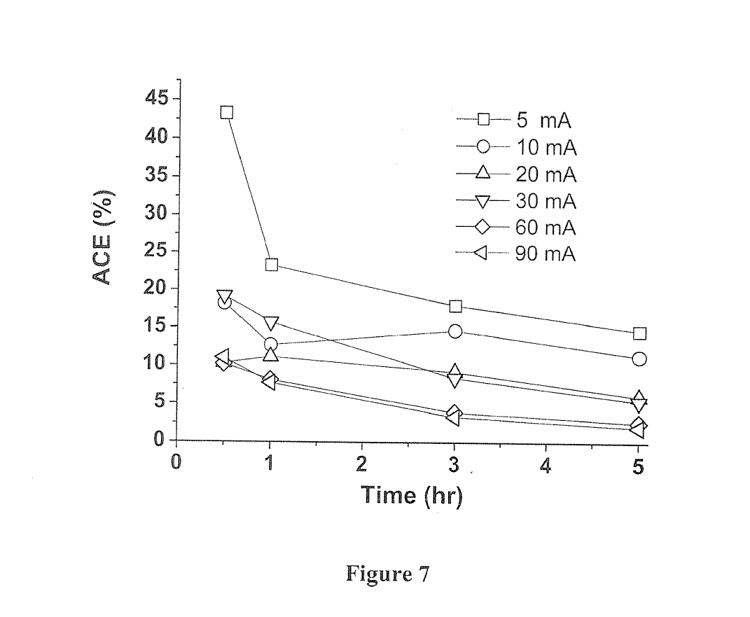

In spite of the low TCE reduction rates at low currents, application of low current results in a better efficiency. Equation 10 is used to calculate the average current efficiency (ACE₍ₜ₎) of TCE reduction from the start (time=0) to a given time t (time=t)

$${ACE}_{( t )} = \frac{\begin{matrix}F ( {V}_{a} + {V}_{h} {H}_{TCE} ) ( {C}_{a ( 0 )} - {C}_{a ( t )} ) \\ ( {\sum }^{j = hydrocarbon compounds} {n}_{j} {𝒳}_{j} )\end{matrix}}{1000 i t {M}_{TCE}} \times 100 \% \qquad ( Eq 10 )$$

where F is the Faraday's constant (96485 C mol⁻¹), nⱼ is the number of electrons transferred from TCE to hydrocarbon compound j, χⱼ is the molar percentage of species j in the total hydrocarbon gases, M_{TCE} is the molecular weight of TCE (131.4 g mol⁻¹), i and t represent current (ampere) and electrolysis time (second). Equation 10 assumes that hydrocarbon gases, including ethene, ethane, acetylene, and methane, are the exclusive final products of TCE electrolytic reduction. In the instant case, acetylene is not detected and the amount of methane is negligible, so only ethene (n=6) and ethane (n=8) are considered for calculation (6≦Σnⱼχⱼ≧8). The molar percentage of these two gases were obtained by measuring the headspace gas at time t. FIG. 7, demonstrates the ACE at different times for 39 mg L⁻¹ initial concentration experiment set. The lowest current, 5 mA, exhibits the highest current efficiency during the 5 h electrolysis, ranging from 43.3% at 0.5 h to 14.7% at 5 h. In contrast, 90 mA showed 11.0% ACE after 0.5 h and constantly decreased to 2.0% after 5 h. Generally, the current efficiency for TCE reduction decreases with increasing the current due to the mass transfer limitation. Considering the rising cell voltage at higher currents, the unit energy consumption climbs to a higher value. Thus, from a practical point of view, the requirement of faster dechlorination or energy efficiency will determine the current levels that should be applied. In batch electrolysis experiments, 30 mA seems the threshold value that achieves FDE value above 95%, k value around 100×10⁻³ L h⁻¹ for three different initial concentrations. Assuming a specific surface area of 5000 m² M⁻³ and a uniform current density distribution on the electrode, 30 mA reflects 0.5 mA cm⁻² current density on copper foam.

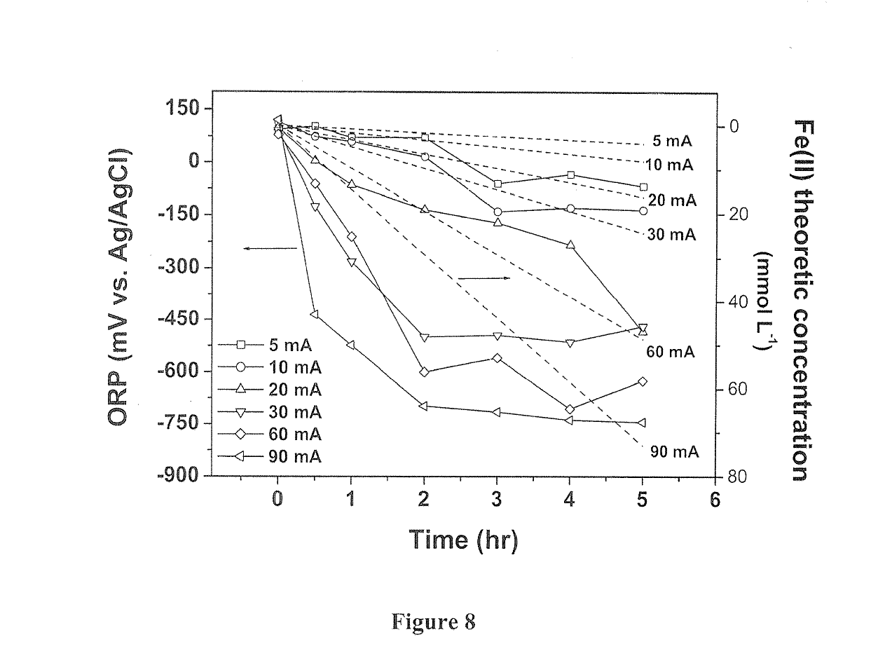

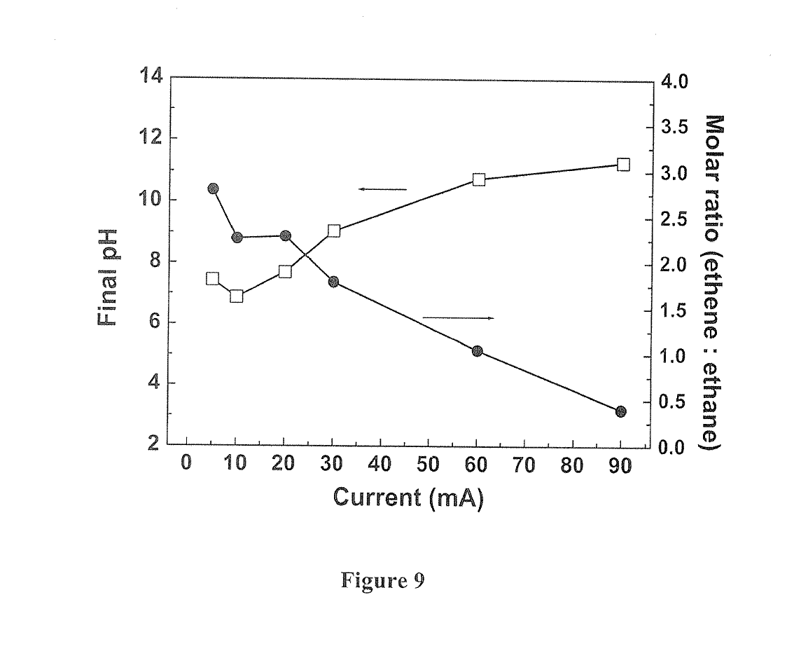

Other information regarding the effect of current on electrolysis can be found in FIG. 8 and FIG. 9. In FIG. 8, the ORP of the electrolyte at different current conditions are presented. The ORP shifts to negative values once the electrolysis starts, and the change rate depends on the current. For 5 and 10 mA currents, the ORP of the electrolyte decreases gradually and levels off above −150 mV. By contrast, a 90 mA current results in a rapid drop of ORP value, showing the buildup of a very reducing electrolyte condition within 0.5 h. Assuming the current efficiency for cast iron dissolution is 100%, the molar concentrations of Fe(II) species (including all soluble and dissolved ferrous species) in the electrolyte should increase linearly with respect to the electrolysis time (the dashed line shown in FIG. 8), and constant decrease of ORP is supposed to occur for all current conditions. However, the profiles of electrolyte ORP in FIG. 8 gradually stabilize at late stages of electrolysis, instead of dropping down constantly. This suggests that the precipitation of ferrous hydroxide and other possible side reactions on the anode (such as passivation or O₂ evolution) (Hansen, H. K. et al. Electrochim. Acta 2007, 52 (10), 3464-3470; herein incorporated by reference in its entirety) prevents the continuous decrease in ORP. The effect of current density on electrolyte final pH and ratio of ethene to ethane are depicted in FIG. 9. The pH vs current plot shows that higher current results in higher final pH value. Considering that maintaining neutral pH is desirable for groundwater remediation, choosing an appropriate current that does not induce a significant pH rising, but still attains reasonable TCE removal rate, is an important design issue. In the instant case, 30 mA seems to balance these two aspects. As for the final products composition, the current (or current density) also plays an important role. At higher currents, the sufficient atomic hydrogens on cathode and ferrous species both favor the generation of ethane, being lower ratio of ethene to ethane.

### Example 2

### Electrochemical Dechlorination of trichloroethylene in a Closed, Liquid-Recirculation System

Chemicals and Materials. The chemicals used include TCE (99.5%, Sigma-Aldrich), cis-dichloroethylene (cis-DCE, 97%, Sigma-Aldrich), hydrocarbon gas standard (analytical standard, 1% (w/w) methane, ethene, acetylene in nitrogen, Supelco), and anhydrous Na₂SO₄ (analytic grade, J T Baker). TCE stock solution was prepared by adding excess pure TCE into 1 liter measuring flask prefilled with 18 MS2 deionized water. The supernatant of the TCE stock solution was used as TCE saturated aqueous solution (1.07 mg mL⁻¹ at 20° C.) for preparation of solutions with different TCE concentrations. Three kinds of anode materials, cast iron (McMaster-Carr, USA), mixed metal oxide (MMO, IrO₂ and Ta₂O₅ coating on titanium mesh, 3N International, USA) and PbO₂ electrode, were tested. The PbO₂ electrode (on titanium mesh substrate) was prepared via electrodeposition method (Mao et al. Russian Journal of Electrochemistry 2008, 44(7), 802-811; herein incorporated by reference in its entirety). Five kinds of plate material, copper (99.9%, VWR, USA), nickel (99.9%, VWR, USA), iron (3N5 purity, ESPI metals, USA), glassy carbon (Alfa Aesar, USA) and silver (99.9%, VWR,USA), and four kinds of foam materials, copper foam (99.99%, 40 PPI, ERG, USA), nickel foam (99%,100 PPI, Lyrun Ltd., China), iron foam (95% iron, 60 PPI, Aibixi Ltd., China) and vitreous carbon foam (40 PPI, ERG, USA) were tested as cathode for TCE reduction. The plate electrodes were round disk (5 cm diameter and less than 2 mm thick). The foam electrodes had the same diameter as plate electrodes, but their thicknesses increased to 6 to 6.35 mm. For copper foam, electrodes with different thicknesses were investigated. Prior to electrolysis experiments, the plate electrodes were polished using by 1# to 3# emery paper, sonicated with 2% Micro-90 cleaning solution (Cole Parmer, USA) and distilled water. The cleaning procedure of foam material includes: washing the electrode with diluted acid (1% HCl), and soaking the electrode in 2% Micro-90 cleaning solution for 10 hours, finally washing the electrode with distilled water prior to assembly.

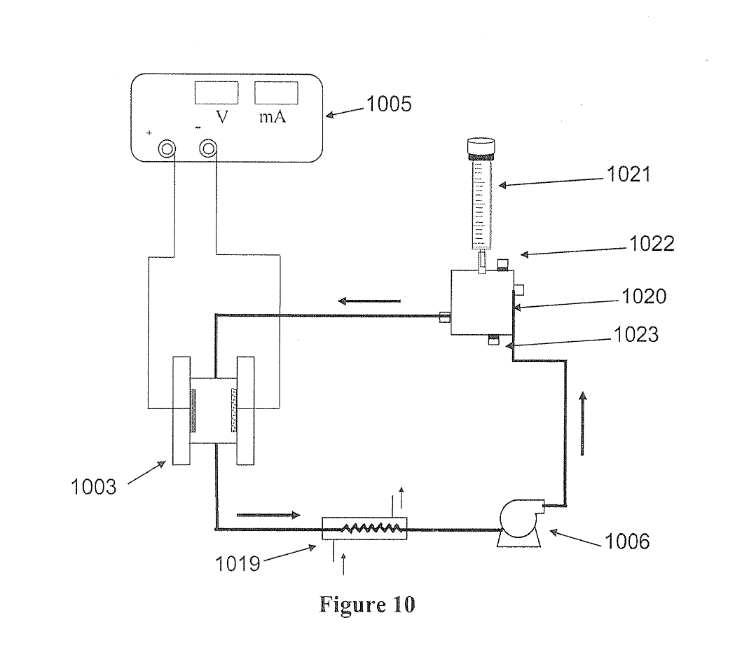

Electrochemical reactor. The setup (FIG. 10) comprises an electrochemical reactor (1003), a power supply (1005), a recirculation pump (1006), a cooling water (20° C.) jacket (1019) and a glass reservoir (1020). The electrochemical reactor was made of acrylic and PTFE material, with a volume of 125 mL. The anode and cathode, with 4 cm spacing, were connected to a power supply (1005) (HP 3160, USA) from the back side of the electrodes. Two pieces of stainless steel or copper washers were used for electrical connections of foam materials. The speed of peristaltic pump was 145 fixed at 320 ml min⁻¹ for all experiments. In order to minimize absorption of TCE, glass tube, PTFE tubing (Cole Parmer, USA) and Viton pump tubing (Cole Parmer, USA) were used to connect all parts of the setup. The headspace of the reservoir was connected to a 180 mL syringe (1021), which allows headspace gas expansion when the internal pressure is higher than 12 kPa. Both headspace gas and liquid samples can be collected from gas sampling ports (1022) and liquid sampling ports (1023) connected to the reservoir. For each experiment, 260 mL aqueous solution of Na₂SO₄ was transferred into the setup and 10 mL TCE saturated solution was injected. For experiments with different initial concentrations of TCE, different volumes of TCE saturated solution were used, but the total volume of electrolyte was maintained at 270 mL for all experiments. The solution was recirculated for 25˜30 minutes to allow equilibrium of TCE in the solution. To ensure the reproducibility of the results, experiments were carried out in duplicates or triplicates. TCE loss through absorption or other mechanism in the overall system was between 5% and 8% (depending on the initial concentration), within 4 hours with respect to the equilibrium concentration.

Analytic methods. Aqueous TCE concentration was measured by Gas Chromatography (GC) using 8610GC instrument with purge-trap system (SRI, USA), flame-ionization detector and MXT-VOL stationary column. Hydrocarbon gases (methane, ethene, ethane and acetylene) in the headspace of electrolytic cell were analyzed by Model 310 GC (SRI, USA) with flame ionization detector and Haysep-T column. Detailed information about the temperature programming of these two measurements are reported in previous work (Mao et al. Environmental Science & Technology 2011, 45(15), 6517-6523; herein incorporated by reference in its entirety). Chloride and sulfate ions concentrations were analyzed by Dionex DX-5500 ion chromatograph (IC). Typically, an aliquot 0.5 ml of supernatant was filtered by a 0.45 μm pore size PVDF syringe filter and transferred into 5 mL vials for IC testing. The IC instrument was also used for the detection of acetic acid and oxalic acid when inert electrodes were applied, and the samples were alkalinized to 10 for measurement. pH, conductivity and oxidation-reduction potential (ORP) of the electrolyte were measured by pH meter, conductivity meter and ORP meter with microprobes (Microelectro, USA). The microprobes allow the measurement of these parameters using a small volume of liquid (0.2 mL). Experiments were also carried out to monitor changes in dissolved oxygen concentration in the electrolyte. In this case, a DO prober (YSI 5000, USA) was mounted on top of water reservoir to measure the DO concentration in electrolyte.

Final transformation efficiency (FTE) of aqueous TCE, final elimination efficiency (FEE) and specific energy consumption (SEC) of the electrochemical process were determined using the following equations:

$$\begin{matrix}FTE = \frac{{C}_{aq ( 0 )} - {C}_{aq ( t )}}{{C}_{aq ( 0 )}} \times 100 \% & ( Eq 11 ) \\ FEE = 1 - \frac{{C}_{aq ( t )}}{{C}_{aq ( 0 )}} [ 1 + \frac{{H}_{TCE} \cdot Δ {V}_{h}}{{V}_{aq} + {H}_{TCE} \cdot {V}_{h}} ] \times 100 \% & ( Eq 12 ) \\ SEC = \frac{I \cdot U \cdot t}{{C}_{aq ( 0 )} \cdot ( {V}_{aq} + {H}_{TCE} {V}_{h} ) \cdot FEE} & ( Eq 13 )\end{matrix}$$

where C_{aq(0)} and C_{aq(t)} are aqueous TCE concentration at time zero and time t (mg L⁻¹); V_{aq} and Vₕ are initial volume of liquid (270 mL) and initial headspace of reservoir (20 mL), respectively. ΔVh is the expanded volume of headspace gas at time t; I is the current intensity (ampere); U is the cell voltage of electrolysis cell (Volt); H_{TCE} is the dimensionless Henry Law constant for TCE, and t is the electrolysis time (second). The FTE is only suitable for comparison of the results of tests with similar headspace, while the FEE is used for accurate calculation of TCE elimination from both solution and headspace.

Multivariable experimental design. A statistical experiment design and analysis were used to investigate the effects of four variables on the response function and to determine optimal conditions to maximize the final elimination efficiency of TCE. This design includes two procedures (Costa Ferreira et al. Journal of Chromatography A 2007, 1158(1-2), 2-14; herein incorporated by reference in its entirety): 1) a series of experiments that follow a certain kind of statistical model are conducted in random chronological order; and 2) variance analysis of the regression results is performed so that the most appropriate model with no evidence of lack of fit can be used to represent the data. The analysis of the experimental data was supported by the statistical software Minitab (Version 14).

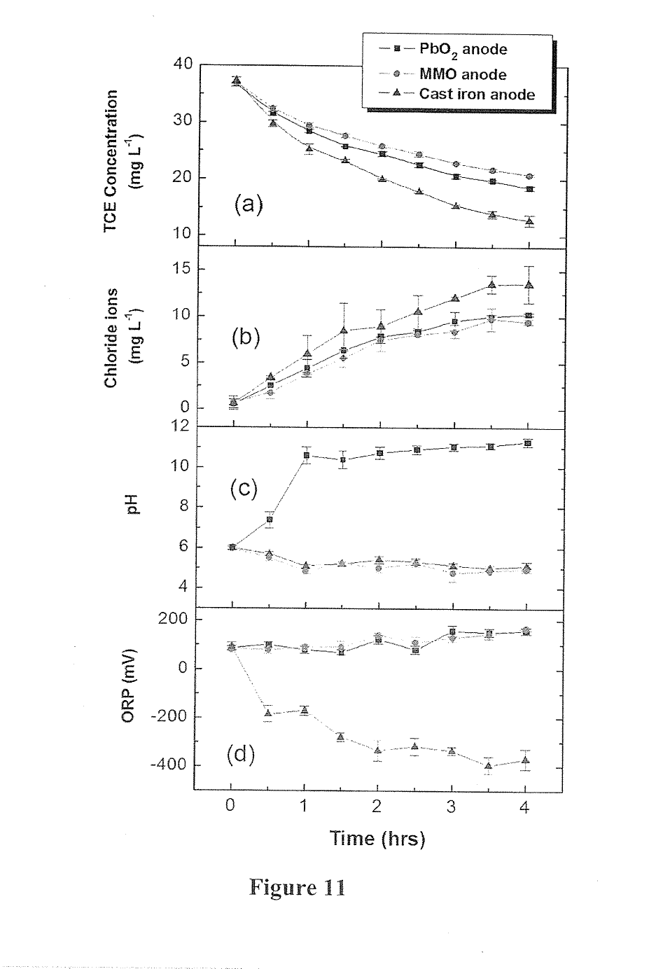

Effect of anode on reductive dechlorination. Constant current electrolysis experiments using silver plate cathode and different anodes were carried out in a closed, recirculated system, and the results are compared in FIG. 11. FIG. 11 shows a comparison of electrolytic dechlorination results using different anodes: (A) aqueous TCE concentration; (B) chloride ions concentration; (C) pH change; and (D) ORP change during electrolysis. Experiments were conducted with silver plate cathode and 80 mA current. The headspace gas expansion volumes (ΔVₕ) after 4-hour electrolysis were 118±1.5 mL for cast iron anode, 106±1.0 mL for PbO₂ anode and 108±1.0 mL for MMO anode. Error bars represent the standard error of the mean of duplicated experiments. The decay of aqueous TCE (FIG. 11A) is fastest in the cell using iron anode, followed by the cell using PbO₂ anode and MMO anode. After 4-hours of electrolysis, up to 65.7% of TCE is transformed when silver plate and iron anode are used. PbO₂ anode caused 5.8% increase in TCE transformation when compared to MMO anode, which is due to the higher performance of PbO₂ anode for destroying organic molecules. After 4 hours of electrolysis, acetic ions and oxalic ions were detected in the system using PbO₂ anode, suggesting that oxidation of TCE did occur under this condition. The reductive dechlorination of TCE on cathode is a process that involves electrons and protons transfer, producing less chlorinated ethenes (e.g., cis-DCE, vinyl chloride) and eventually non-toxic hydrocarbons, as given by,

C₂HCl₃+me⁻+nH⁺=C₂Hₙ₊₁Cl₃₋ₘ₊ₙ+(m−n)Cl⁻ (Eq 14)

Because no chlorinated ethene accumulation is found in the electrolytic cells in this study, Eq. 14 can be further simplified to Eq. 15.

C₂HCl₃+me⁻+(m−3)H⁺=C₂H_{m 2}+3Cl⁻ (wherein m=4, 6, 8, 10; m=10 represents two methane molecules) (Eq 15)

Thus, the increase of chloride ion concentration in the electrolyte should reasonably correspond to the progressive decrease of TCE since all chlorine atoms are transferred to chloride ions. In FIG. 11B, a higher buildup of chloride ion concentration is found in the cell using iron anode, supporting the observation of aqueous TCE decay. Calculations based on chlorine mass show less than 85% mass recovery for chlorine in the three electrolytic systems. In the system using iron anode, the mass lost in chlorine can be in part explained by the absorption on ferrous hydroxide and formation of ferrous and ferric chloride complexes in solution (Cornell, R. M. and Schwertmann, U., 2003. The Iron Oxides: Structure, Properties, Reactions, Occurrences and Uses, Wiley-VCH, Weinheim, Germany.; Langmuir, D. Aqueous Environmental Geochemistry Prentice Hall, Upper Saddle River, N.Y., USA 1997; and Roh et al. Environmental Geology 2000, 40(1-2), 184-194; each herein incorporated by reference in its entirety). Some chloride ions, derived from dechlorination of TCE, are not detected by the IC for mass recovery calculation. For the inert anodes, the mass lost in chlorine is probably due to the generation of free chlorine (or other chlorinated intermediates) on the anode (Al-Abed, S. R. and Fang, Y. X. Chemosphere 2007, 64(3), 462-469; herein incorporated by reference in its entirety).

The electrolyte pH in the cells using inert anodes did not show (FIG. 11C) any considerable change during electrolysis, indicating the protons (H⁺) produced at the anode are quickly neutralized by the hydroxyl ions (OH⁻) produced at the cathode. However, the pH of the electrolyte in the cell using iron anode immediately increases once electrolysis starts and stabilizes at a pH of 11.3. The dissolution of ferrous ions from the cast iron anode, instead of proton and oxygen evolution, is the dominant reaction, and the ferrous ions subsequently combine with the hydroxyl ions from the cathode, forming Fe(OH)₂ precipitates. However, due to the relatively higher solubility of Fe(OH)₂ (Kₛₚ is 7.08×10⁻¹⁶; Cornell, R. M.; Schwertmann, U. The Iron Oxides: Structure, Properties, Reactions, Occurrences and Uses, 2nd ed.; Wiley-VCH: Weinheim, Germany, 2003; herein incorporated by reference in its entirety), presence of free Off in the electrolyte results in an increase in the pH. The generated ferrous species also induce different ORP conditions in electrolytes. The ORP of the electrolyte using inert anodes increases slightly as electrolysis proceed, finally reaching an oxidizing ORP of more than 150 mV. In contrast, when iron anodes were used, the ORP of the electrolyte constantly decreases during electrolysis, indicating buildup of reducing electrolyte conditions.

In this recirculation system, an enhancing effect on TCE dechlorination is observed when iron anodes are used, which is consistent with the results in batch electrolysis system (See Example 1 and Mao et al. Environmental Science & Technology 2011, 45(15), 6517-6523; herein incorporated by reference in its entirety). As reported in Mao et al (2011), the enhancing effect of iron electrolysis is due to the presence of the ferrous species. Fe(OH)₂ or other ferrous species (e.g., Fe(OH)⁺, Fe(OH)₄⁻) have a strong tendency to consume other oxidizing chemicals in the electrolyte, especially dissolved oxygen (Mao et al. Environmental Science & Technology 2011, 45(15), 6517-6523; herein incorporated by reference in its entirety). The dissolved oxygen concentration was monitored in the recirculation system with different anodes (same electrolytic conditions as that in FIG. 11, but in separate experiment). The results show that the dissolved oxygen concentrations in electrolyte (measured in water reservoir) were maintained at about 10˜13 mg L⁻¹ when MMO anodes or PbO₂ anodes were used. In contrast, when cast iron anode was used, the dissolved oxygen concentration in the electrolyte dramatically decreased to 0.1 mg L⁻¹ after thirty minutes of electrolysis. Therefore, although the electrolyte flow condition of this study is different from the batch experiments, an enhancing effect of cast iron on TCE dechlorination is observed. The dissolved oxygen quickly reacted with ferrous hydroxide, and the electron or proton competition effect from oxygen reduction is completely eliminated. Based on the observations in this study, the anodic reactions basically play opposing roles for TCE degradation when inert anodes are typically used. Oxygen generated can disturb the reductive dechlorination on cathode.

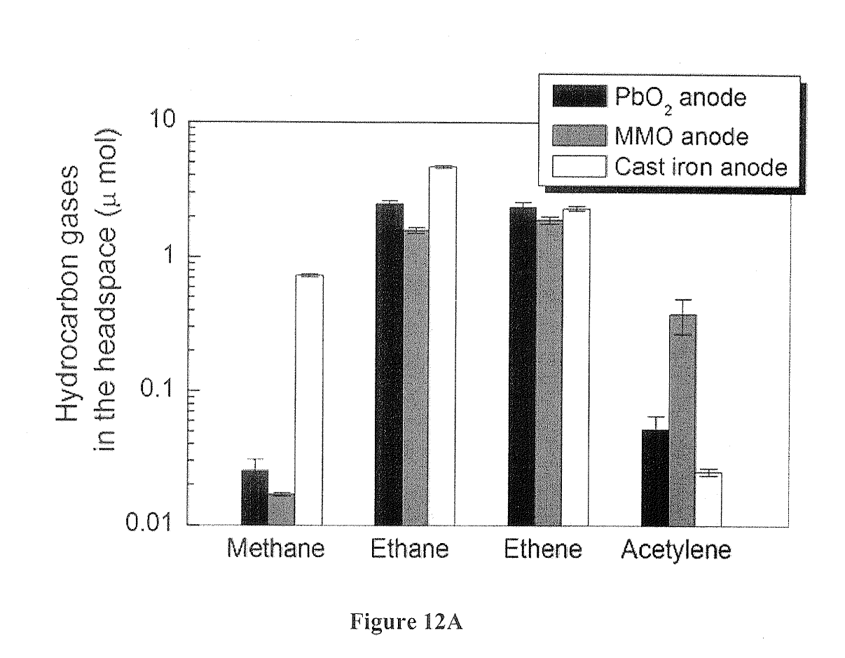

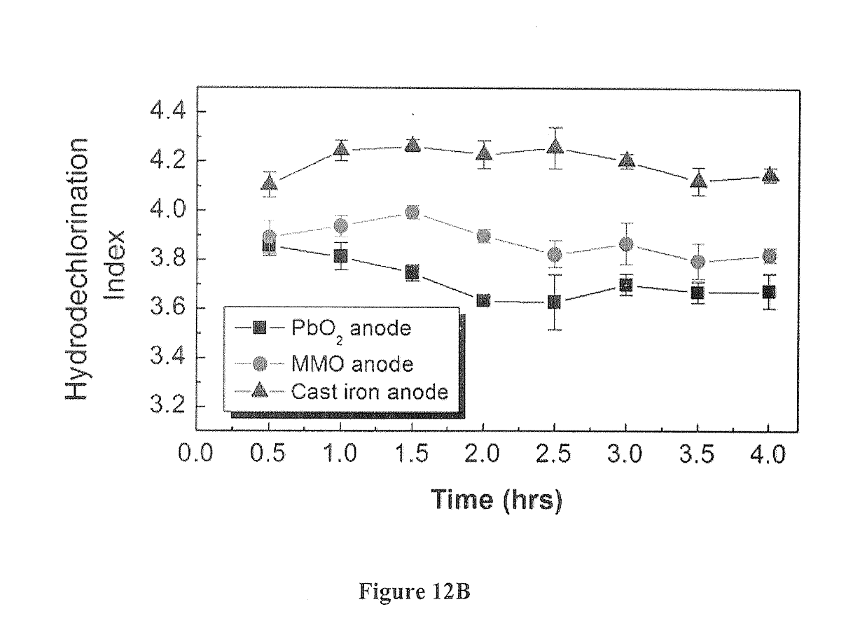

In addition to the differences in aqueous TCE transformation rates, the products of transformation also reflect the competition effect of O₂ when inert anode is used. Only four hydrocarbon gases (methane, ethene, ethane and acetylene) were detected as the final products of TCE dechlorination. This is in agreement with previous findings (Chen et al. Journal of Applied Electrochemistry 2003, 33(2), 161-169; Li, T. and Farrell, J. Environmental Science & Technology 2000, 34(1), 173-179; and Mao et al. Environmental Science & Technology 2011, 45(15), 6517-6523; each hereby incorporated herein by reference in its entirety). In FIG. 12A, the headspace hydrocarbon gases in the water reservoir are compared after 1.5 hours electrolysis. For the iron anode, more methane and ethane are found in the headspace of water reservoir, and the total amount of hydrocarbon gases apparently exceed the amount of the gases generated under the other two conditions (FIG. 12A). Blank experiments (without TCE) with iron anodes did not show formation of these hydrocarbon gases. A parameter, hydrodechlorination index (HI) is proposed for quantitative comparison of the TCE transformation products,

$$Hydrodechlorination Index = {\sum }^{j = hydrocarbon compounds} {n}_{j} {𝒳}_{j} \qquad ( Eq 16 )$$

where the nⱼ is the number of the hydrogen atoms by which TCE is transformed to hydrocarbon compound j (e.g., n_{acetylene}=1, nₑₜₕₑₙₑ=3, nₑₜₕₐₙₑ=5 nₘₑₜₕₐₙₑ=3.5), χⱼ is the molar percentage of species j in the total hydrocarbon gases of headspace. The HI values of the headspace hydrocarbon gases in three electrolytic cells are summarized in FIG. 12B. The HI value for iron anode electrolysis starts at 4.04 after thirty minutes and stabilizes at 4.2, being higher than the HI value of inert anode electrolysis. Under identical electrolysis condition, higher HI value means that more hydrogen atoms are acquired in the dechlorination process. In other words, it means the cathodic process can provide more atomic hydrogens (H₂O+e=H.+OH⁻) (Li, T. and Farrell, J., Environmental Science & Technology 2001, 35(17), 3560-3565; hereby incorporated herein by reference in its entirety) for TCE reduction because the competition process from O₂ reduction is reduced (or eliminated) in the iron anode electrolysis.

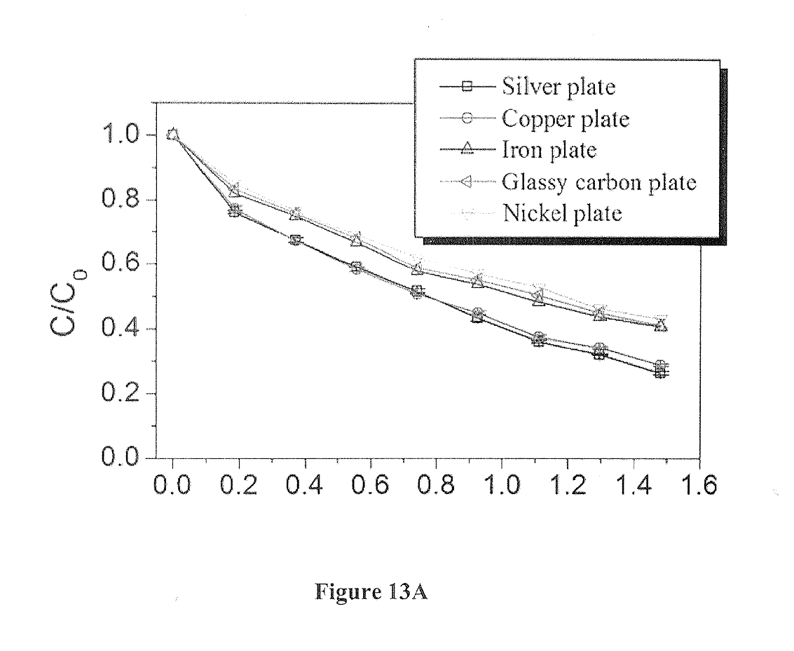

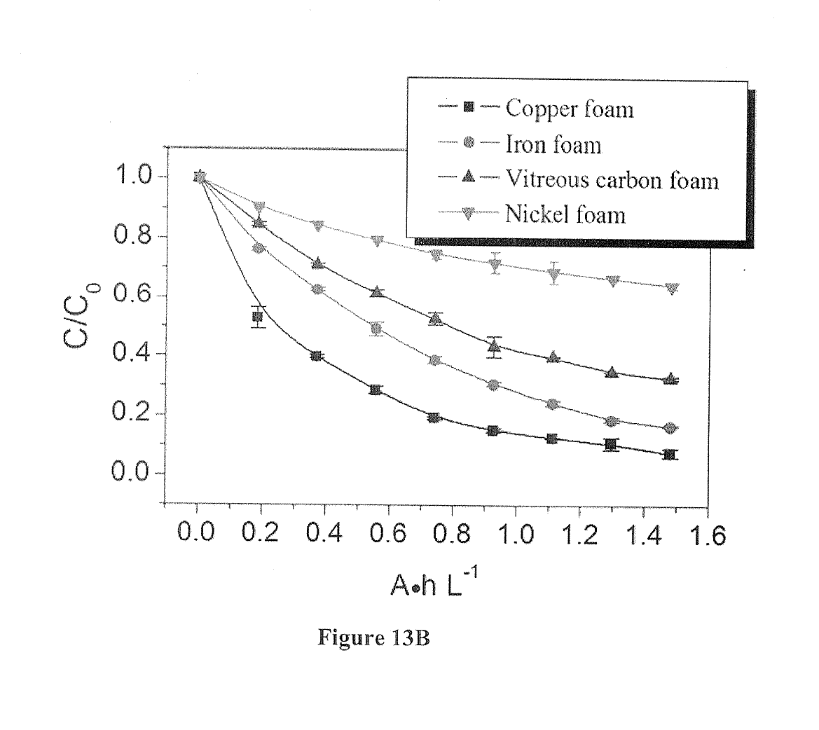

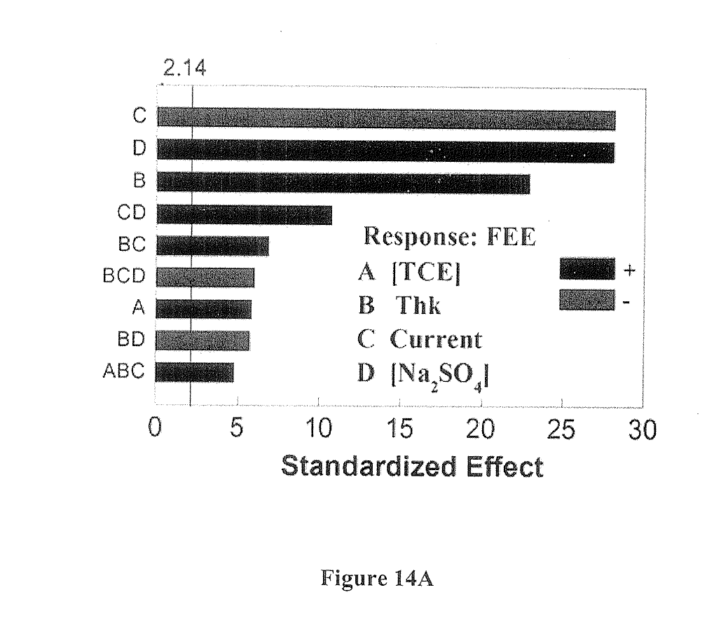

Effect of cathode material. The performances of different cathode materials on TCE dechlorination are compared using galvanostatic electrolysis experiments under flow. The headspace gas expansion volumes in all experiments varied from 136 mL to 143 mL after 4 hours electrolysis at 100 mA. The decay of normalized aqueous concentration of TCE is shown in FIG. 13. Silver and copper materials exhibit better electrocatalytic performances in comparison with other plate materials by achieving more than 70% aqueous TCE transformation (FTE). The iron, glassy carbon and nickel plate cathodes show similar performance on TCE dechlorination with FTE less than 60%. Foam materials, such as copper foam cathode (FIG. 13B), increased the FTE to 92.3%, or 21.1% higher than that of copper plate electrode. Iron foam and vitreous carbon foam also show enhancing effect in comparison to the corresponding plate materials. Only nickel foam show inferior performance with respect to plate materials.

The TCE hydrogenation (Eq. 14) and hydrogen evolution (Eq. 3 and Eq. 4 from Example 1) are competitive reactions that proceed simultaneously on the surface of the cathode.

The electrodes catalytic activity on hydrogen evolution may explain their different TCE dechlorination rates. For materials with higher hydrogen evolution overpotential, such as silver, copper and lead (Halmann, M. M., 1993. Chemical Fixation of Carbon Dioxide: Methods for Recycling CO₂ into Useful Products, CRC Press, Boca Raton, Fla., USA., pp. 81; hereby incorporated by reference herein in its entirety), the kinetics of Eq.4 (hydrogen evolution) may be relatively slow, and TCE molecules have better chances to acquire the atomic hydrogen from the cathode. On the contrary, electrodes with lower hydrogen evolution overpotential, such as nickel (Halmann, M. M., 1993. Chemical Fixation of Carbon Dioxide: Methods for Recycling CO₂ into Useful Products, CRC Press, Boca Raton, Fla., USA. , pp. 81; hereby incorporated by reference herein in its entirety), may represent faster kinetics for Eq. 4 (Jeremiasse et al. International Journal of Hydrogen Energy 2010, 35(23), 12716-12723; hereby incorporated by reference herein in its entirety), which will lower the probability of TCE molecules acquiring atomic hydrogen. Therefore, when the working area of nickel significantly increases from plate to foam, less degradation of TCE was observed since nickel foam results in lower hydrogen evolution overpotential and facilitates hydrogen release (Jeremiasse et al. International Journal of Hydrogen Energy 2010, 35(23), 12716-12723; hereby incorporated by reference herein in its entirety).

Although oxygen reduction is eliminated in the cell by using iron anode, the competitive reduction of sulfate is another possible consideration for dechlorination of TCE. Based on the standard potential data and previous studies, sulfate can be reduced by atomic hydrogen in aqueous solution (Bilal, B. A. and Tributsch, H. Journal of Applied Electrochemistry 1998, 28(10), 1073-1081; and Yang et al. Environmental Science & Technology 2007, 41(21), 7503-7508; each hereby incorporated by reference herein in its entirety). A batch electrolysis experiment using copper foam cathode and separated cell (by Nafion® membrane) was carried out to understand the impact of sulfate reduction on cathode. Only 1.8% of sulfate ions concentration decreased in the catholyte after 4-hour electrolysis (200 mL catholyte, 100 mA, 0.01 M Na₂SO₄, without TCE). Thus, it suggests that sulfate reduction on the cathode does not have an appreciable effect on TCE reduction under the testing conditions of this study.

Optimization of Electrolysis Process.

Regression model and assessment of the main factors. The combination of iron anode and copper foam cathode result in the highest TCE dechlorination performance compared to other materials tested. Due to cast iron anode, the cathodic reduction of aqueous TCE can be further optimized under reducing electrolyte condition, using a multivariable experiment design (Rezzoug, S. A. and Capart, R. Energy Conversion and Management 2003, 44(5), 781-792; and Wei et al. Separation and Purification Technology 2011, 77(1), 18-25; each hereby incorporated by reference herein in its entirety). In addition to the electrode type, the process can be affected by other operating variables, such as flow rate of aqueous solution, current, temperature, and supporting electrolyte. In this study, four variables including (A) initial concentration of TCE, (B) surface area represented by thickness of copper foam electrode, (C) current intensity and (D) concentration of supporting electrolyte (Na₂SO₄) are selected for further investigation. The experimental range and levels of variables used in the factorial design are listed in Table 3.

TABLE 3
Range of variation of parameters used in experimental design.

| Parameter | Notation | Low (−1) | Center (0) | High (+1) |
|---|---|---|---|---|
| A^{a} | [TCE] (mg L⁻¹) | 28 | 42 | 56 |
| B^{b} | Thickness of foam | 3.175 | 6.35 | 9.525 |
| | cathode (Thk) (mm) | | | |
| C^{c} | Current (mA) | 40 | 80 | 120 |
| D^{d} | [Na₂SO₄] (mol L⁻¹) | 0.002 | 0.022 | 0.042 |

^{a}Initial concentration of aqueous TCE were obtained by spiking 8 mL, 12 mL and 16 mL TCE saturated solution.
^{b}Surface area of foam electrodes (provided by manufacturer) is 145 cm² (3.175 mm), 290 cm² (6.35 mm), and 435 cm² (9.525 mm).
^{c}Electrolysis time at three levels was 6 h (40 mA), 3 h (80 mA), and 2 h (120 mA).
^{d}Ionic conductivity of the electrolyte at three levels was 480 μS cm⁻¹, 4.31 mS cm⁻¹, and 7.60 mS cm⁻¹.

Among these factors, thickness of the electrode is proportional to the surface area of electrode, and conductivity of electrolyte increases almost linearly with the concentration of Na₂SO₄. Different electrolysis times (2, 3, and 6 hours) were selected to maintain identical total applied charge (240 mAh) for all experiments. The experimental design matrix, listed in Table 4, consists of three series of experiments (Deepak et al. Bioresource Technology 2008, 99(17), 8170-8174; and Wei et al. Separation and Purification Technology 2011, 77(1), 18-25; each hereby incorporated by reference herein in its entirety): (i) a two-level full factorial design 2⁴ (all possible combinations of codified values +1 and −1); (ii) six central, replicates of central point (0); and (iii) eight axial or star point located at the center and both extreme levels of the experimental models.

TABLE 4
Experimental data of the multivariable experiment design.^{a}

| | Variable levels | | | | Expended gas | Cell | Y1 | Y2 (SEC) |
|---|---|---|---|---|---|---|---|---|
| Exp. No. | A [TCE] | B (Thk) | C (I) | D [Na₂SO_{4]} | volume (mL) | voltage (V) | (FEE) (%) | (kWh kg⁻¹) |
| 1 | −1 | 1 | −1 | 1 | 77 | 0.51 | 99.01 | 15.43 |
| 2 | 1 | 1 | 1 | 1 | 82 | 0.82 | 94.84 | 13.35 |
| 3 | 1 | 1 | −1 | −1 | 80 | 5.1 | 93.02 | 84.45 |
| 4 | 1 | −1 | 1 | −1 | 89 | 27.1 | 70.87 | 580.47 |
| 5 | 1 | −1 | 1 | 1 | 83 | 0.88 | 87.00 | 15.45 |
| 6 | 1 | −1 | −1 | −1 | 78 | 5.9 | 89.74 | 102.19 |
| 7 | 0 | 0 | 0 | 0 | 81 | 2.9 | 88.58 | 72.98 |
| 8 | −1 | −1 | −1 | −1 | 80 | 5.6 | 86.00 | 196.16 |
| 9 | 0 | 0 | 0 | 0 | 81 | 2.9 | 88.94 | 69.81 |
| 10 | −1 | −1 | 1 | 1 | 84 | 0.85 | 87.79 | 29.81 |
| 11 | −1 | 1 | −1 | −1 | 80 | 5.2 | 93.05 | 171.34 |
| 12 | −1 | −1 | 1 | −1 | 85 | 27.7 | 68.02 | 1222.46 |
| 13 | 1 | 1 | −1 | 1 | 80 | 0.42 | 98.49 | 6.49 |
| 14 | −1 | 1 | 1 | −1 | 84 | 27.0 | 82.10 | 972.92 |
| 15 | −1 | −1 | −1 | 1 | 81 | 0.55 | 91.01 | 18.69 |
| 16 | 0 | 0 | 0 | 0 | 82 | 2.9 | 88.54 | 68.65 |
| 17 | 1 | 1 | 1 | −1 | 80 | 27.1 | 86.10 | 488.01 |
| 18 | 1 | −1 | −1 | 1 | 83 | 0.6 | 95.87 | 9.66 |
| 19 | −1 | 1 | 1 | 1 | 78 | 0.85 | 91.90 | 28.67 |
| 20 | 0 | 0 | 0 | 0 | 81 | 3.0 | 89.10 | 71.77 |
| 21 | 0 | 0 | 0 | 0 | 82 | 2.9 | 89.74 | 69.27 |
| 22 | 0 | 0 | 0 | −1 | 84 | 20.0 | 82.75 | 493.18 |
| 23 | 0 | −1 | 0 | 0 | 81 | 3.0 | 83.69 | 74.51 |
| 24 | 0 | 0 | 1 | 0 | 82 | 4.0 | 82.97 | 100.33 |
| 25 | 0 | 0 | 0 | 0 | 80 | 3.0 | 88.85 | 71.75 |
| 26 | 0 | 0 | 0 | 1 | 80 | 1.9 | 94.02 | 42.49 |
| 27 | 0 | 1 | 0 | 0 | 81 | 2.0 | 93.56 | 63.86 |
| 28 | −1 | 0 | 0 | 0 | 81 | 3.0 | 88.69 | 112.13 |
| 29 | 1 | 0 | 0 | 0 | 80 | 2.9 | 89.96 | 49.42 |
| 30 | 0 | 0 | −1 | 0 | 80 | 1.7 | 93.97 | 36.60 |

^{a}The cell voltage is the mean of five cell voltage values recorded, with equal time intervals, from the start to the end of electrolysis. Values in each trial were the average of duplicates.

Experiments were conducted in random order and the results are summarized in

Table 4. Using the factorial experiment analysis in MINITAB software, semi-empirical expressions at 95% of confidence level can be obtained for the response of final elimination efficiency (Y1(FEE)) and theresponse of specific energy consumption (Y2 (SEC)),

Y1(FEE)=88.603+1.02A+4.002B−4.916C+4.907D−0.265AB+0.057AC−0.256AD+1.273BC−1.061BD+1.988CD+0.875ABC+0.059ABD−0.331ACD−1.109BCD+0.264ABCD (R²=0.994) (Eq 17)

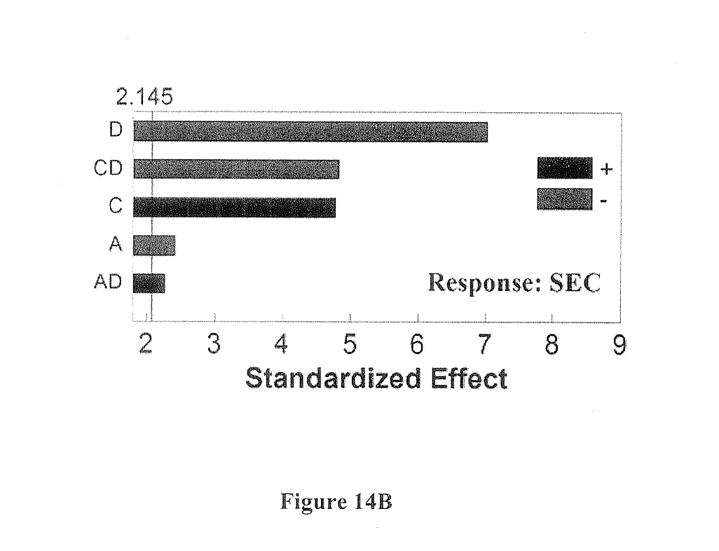

Y2(SEC)=178.4−78.8A−22.5B+156.1C−229.5D+10.2AB−59.9AC+78.8AD−18.5BC+23.4BD−167CD+9.3ABC−10.3ABD+58.4ACD+18.9BCD−9.4ABCD (R²=0.890) (Eq 18)

where A, B, C and D take values between −1 and 1, representing the level of a factor. The model produced R-squared values of 0.994 and 0.890 for FEE and SEC, respectively. The p-value of lack-of fit shows that the model of the FEE response is significant (p-value>0.05); while the model on SEC response is insignificant. It is not surprising that SEC model is insignificant since the variation of the potential of anode also contributes to the cell voltage, which is crucial to the SEC calculation. To visualize the importance sequence of the calculated factors, the single factor and interaction factors are depicted in rank order in the form of Pareto chart (FIG. 14). The absolute value of the standardized effect of a factor overpassing the significance line (the vertical line at 2.14 and 2.145 in FIG. 14) means it exerts a statistically significant influence on the response. The signs + and − represent positive and negative effects, respectively. Positive effect means the increases of response in the presence of high levels of the respective factors within the range studied, while the negative effect indicates the decrease of response in the presence of high levels of the factors. Positive quadratic or third order polynomial coefficients indicate a synergistic effect, while negative coefficients represent a negative effect between or among the factors. In FIG. 14A, the most significant individual factor for FEE is the applied current (C), followed by the Na₂SO₄ concentration (D) and the thickness of electrode (B), whereas the initial concentration of TCE showed much less importance. On the other hand, the analysis shows that the FEE is also affected by some quadratic interaction factor (CD, BC, BD) and third order polynomial factors (BCD, ABC). For the specific energy consumption, as shown in FIG. 14B, five factors are statistically significant based on 95% confidence intervals: the Na₂SO₄ concentration, the current, the initial TCE concentration, and two quadratic factors (CD and AD).

Effect of Na₂SO₄ concentration. Among these four individual factors, the Na₂SO₄ concentration is important for both FEE and SEC. As mentioned above, Na₂SO₄ is almost an inert supporting electrolyte and it will not exert appreciable effect on the degradation of TCE through chemical route, because of its low reactivity on either cathode or anode. However, the Na₂SO₄ concentration significantly changes the conductivity of electrolyte, which can impact the electrochemical process when a 3D porous electrode is adopted. When the copper foam is working as a cathode, the potential of the metal phase (E) is constant throughout the network of copper foam due to the excellent electron conductivity of copper. This potential is composed of four parts (He et al. Industrial & Engineering Chemistry Research 2004, 43(25), 7965-7974), as shown in Eq. 19, the equilibrium potential of the rate-limiting reaction step (E_{eq}), the electron transfer overpotential (ηₑ), the concentration overpotential (η_{c}), and solution potential (φₛ).

E=E_{eq}+ηₑ+η_{c}+φₛ (Eq. 19)

When a cathodic reaction is in progress, solution potential is related to solution electrolytes conductivity and shows increasing trend from the surface to the inner part of foam electrode, hence the electron transfer overpotential (ηₖ) of the inner part decreases to maintain constant electrode potential (E). As a result, the current (or electron discharge) mostly distribute on the outmost layer of foam electrode (with respect to anode direction), which causes strong hydrogen evolution on the surface layer and lower the real reaction area for TCE reduction. In contrast, high ionic conductivity of the electrolyte will bring more homogenous solution potential and electron discharge in the network of the foam electrode, increasing the probability of TCE acquiring the atomic hydrogen. As for the specific energy consumption, apart from the high FEE at higher Na₂SO₄ concentration, higher ionic conductivity decrease the cell voltage greatly (see Table 4), resulting in less energy consumption (negative effect in FIG. 14B).

Effect of current. In the range of 40 to 120 mA, the electrical current significantly impacts the FEE and SEC not only at first order but also at quadratic level. Under the constant-charge but different current condition, the headspace gas expansion volume in these 30 experiments varied around 80 mL and did not show remarkable difference, indicating that the current level did not change the primary reaction process on the cathode (hydrogen evolution). Based on the results of the FEE, the advantages of applying lower current can be concluded as follows: 1) the lower level of current will not cause excessive release of hydrogen gas and decrease the effect of mass-transport limiting; 2) lower current means more detention time and reaction time; 3) lower current brings out less iR drop in solution, favoring a more homogenous current distribution. Therefore, from a perspective of engineering operation, low current is much more preferred if the detention time of the contaminated water is not a primary factor.

Thickness of foam electrode. As expected, the thickness of foam electrode is an important factor that influences the FEE of TCE positively, even if it is less important than the current and the Na₂SO₄ concentration. Although the surface area increases linearly with increasing electrode thickness (see note in Table 3), there is no significant increase in TCE removal efficiency. When other factors are at middle level, 9.525 mm electrode exhibited 93.56% FEE of TCE, being only 9.87% higher than that of 0.125 mm thickness electrode. This suggests that a large area of the foam electrode did not contribute at the same rate when the surface area increased significantly. While thicker electrodes have larger surface area, it may be more difficult to achieve sufficient electron-transfer potential for the inner part of the foam electrode because of the increasing iR drop.

Initial TCE concentration. For the experimental range of 28 to 56 mg L⁻¹, the initial TCE concentration had an impact on both FEE and SEC. Although initial TCE concentration was doubled from 28 mg L⁻¹ to 56 mg L⁻¹; except for Exp. No. 4, the final aqueous TCE concentrations for all experiments were all below 10 mg L⁻¹ (not shown). At high initial concentration, due to the large surface area of foam cathode, the chemisorption of TCE on foam electrode is accordingly enhanced. This ensures that foam maintains relatively high efficiency for a wide range of TCE concentration. Therefore, a positive impact on FEE and a negative impact on SEC (higher initial concentration gives less energy consumption) are observed in the multivariable experiments.

Contour Diagrams and Optimum Conditions.

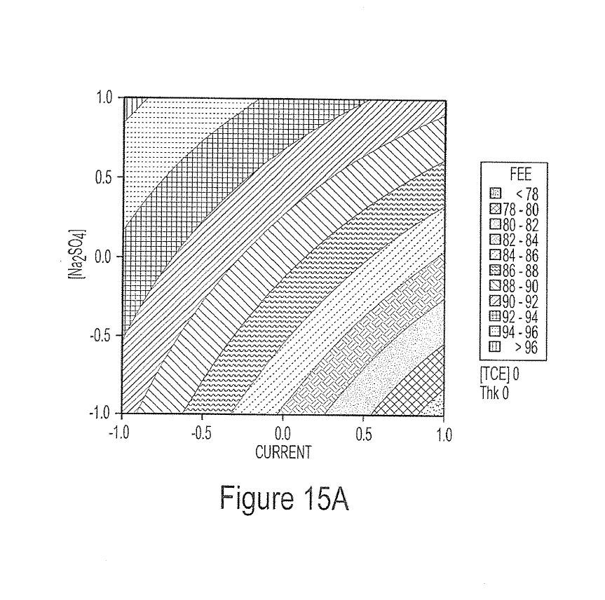

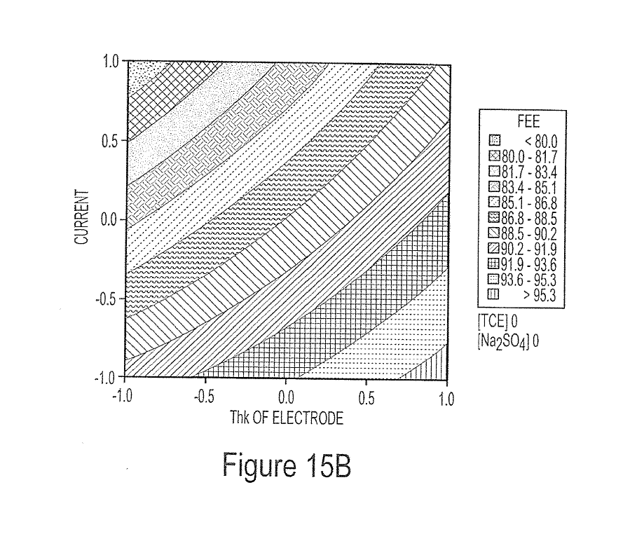

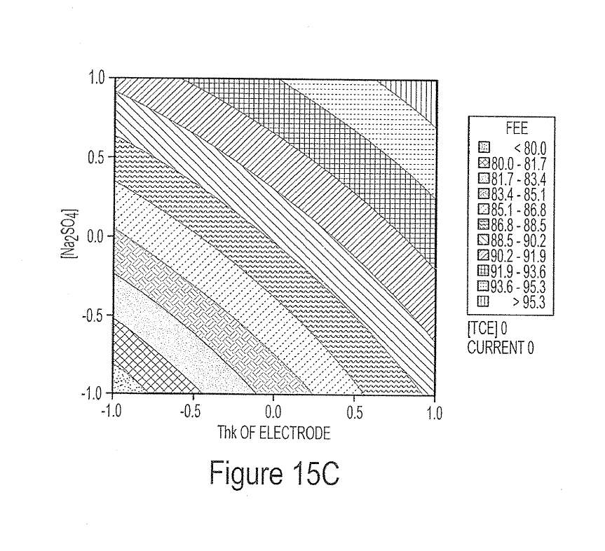

After screening the controlling factors, the response surface analysis using contour diagram can be generated, in order to determine the optimum conditions for removal of TCE. In FIG. 15, three important pairs of factors are displayed in contour plots of FEE of TCE: Na₂SO₄ concentration of versus current (FIG. 15A), current versus thickness of electrode (FIG. 15B), and Na₂SO₄ concentration versus thickness of electrode (FIG. 15C). Each contour plot has an infinite number of combinations based on two selected factors while maintaining the two other factors constant at their middle values (level “0”). The obliquely orientated contours in these three plots indicate that the interactions between the corresponding factors were always significant in the experimental range. The optimal conditions for highest FEE are depicted in these plots. As shown in FIG. 15A, the highest FEE (>96%) can be achieved when the concentration of Na₂SO₄ is higher than 0.0388 mol L⁻¹ (0.84 in FIG. 15A) and the current is lower than 46 mA (−0.85 in FIG. 15A). The foam electrode features very large surface area, and the conductivity of electrolyte determines the extent of effective utilization of the real surface area. Lower current, but same amount of total electrical charge, means more reaction time and facile hydrogen evolution. Thus, these two factors and their interaction are important for the FEE. In FIG. 15B, the optimal range for the highest FEE (>95.3%) is that current is lower than 50 mA and thickness of electrode exceeds 8.41 mm. As seen in FIG. 15C, more than 95.3% of FEE can be obtained when the Na₂SO₄ concentration excesses 0.036 mol L⁻¹ and the electrode is thicker than 8.34 mm. Generally, based on the results of the multivariable experiments, the optimal combination of the operation conditions for response FEE is: 40 mA current, 9.525 mm foam electrode and 0.042 mol L⁻¹ Na₂SO₄. The TCE initial concentration is a less important efficiency-determining factor, indicating that the large surface area of foam electrode enables it to adapt to a wide range of TCE concentration.

It is also noteworthy that, even at low conductivity (0.002 mol L⁻¹Na₂SO₄) solution, high TCE removal efficiency still can be achieved if the current is applied at low level (see FIG. 15A). Considering that the ionic conductivity of groundwater is usually more than 500 μS cm⁻¹, being higher than the conductivity of 0.002 mol L⁻¹Na₂SO₄, the present electrolysis system of copper foam cathode and cast iron anode is applicable to groundwater remediation. The implementation of the present system can be flexible: it can be powered by either normal electrical power for an ex-situ remediation, or a photovoltaic power for an in-situ remediation of groundwater contaminated by chlorinated solvents.

TCE in recirculated aqueous solution is rapidly removed through an electrolysis system that consists of cast iron anode and copper foam electrode. The cast iron anode generates a reducing electrolyte and prevents the electron and proton competition from dissolved oxygen, thus the reduction of TCE on the cathode is enhanced. The Hydrodechlorination Index reflects that fast TCE transformation occurs in the reducing electrolyte due to highly available atomic hydrogen on cathode. In screening of different cathode materials in a recirculated system, copper foam electrode exhibits superior performance on TCE transformation. Through a multivariable experiment design; the electric current, Na₂SO₄ concentration (representing conductivity), thickness of foam electrode (or surface area of electrode), and initial TCE concentration were identified as the individual factors that impact TCE removal efficiency. Higher electrolyte conductivity facilitates better current distribution on the foam electrode, promoting electrochemical dechlorination of TCE. The copper foam electrode exhibits high TCE removal efficiency in a wide range of initial concentration and Na₂SO₄ concentration. The optimal combination for aqueous TCE elimination is high electrolyte conductivity, high surface-area electrode and lowest applied current for a specific electric charge application. With the optimal condition, the final elimination efficiency of TCE can reach up to 98%, and the corresponding energy consumption is 6.49 kWh kg⁻¹.

### EQUIVALENTS

Upon review of the description and embodiments of the present invention, those skilled in the art will understand that modifications and equivalent substitutions may be performed in carrying out the invention without departing from the essence of the invention. Thus, the invention is not meant to be limiting by the embodiments described explicitly above, and the various equivalents are intended to be encompassed within the scope of the claims which follow.

1. An apparatus for reduction of contaminants in groundwater comprising:
(a) a metal iron anode,
(b) a high specific surface area cathode,
(c) a power supply in electrical communication with the anode and cathode; and
(d) optionally, a conduit for introducing ground water into the apparatus,
wherein when the conduit is not present, the anode and cathode are configured to enable introduction of the anode and cathode into a ground water source.

2. The apparatus of claim 1, wherein the groundwater is from an aquifer, cistern, well, reservoir, spring, river or lake.

3. The apparatus of claim 1, wherein the anode comprises at least about 90% iron.

4. The apparatus of claim 3, wherein the anode comprises at least about 95% iron.

5. The apparatus of claim 1, wherein the anode is cast iron, iron rod, iron plate, or scrap iron.

6. The apparatus of claim 1, wherein the specific surface area is from about 400 m²/m³ to about 6500 m²/m³.

7. The apparatus of claim 6, wherein the specific surface area is from about 1000 m²/m³ to about 6500 m²/m³.

8. The apparatus of claim 7, wherein the specific surface area is from about 5000 m²/m³ to about 6000 m²/m³.

9. The apparatus of claim 1, wherein the cathode comprises metal foam, copper plate or silver plate.

10. The apparatus of claim 9, wherein the cathode comprises copper foam or silver foam.

11. The apparatus of claim 10, wherein the cathode comprises copper foam.

12. The apparatus of claim 1, wherein the cathode has a mean pore size of at least about 100 μM.

13. The apparatus of claim 12, wherein the cathode has a mean pore size of at least about 200 μM.

14. The apparatus of claim 1, wherein the contaminants are halogenated organics.

15. The apparatus of claim 1, wherein the conduit is in contact with a groundwater source.

16. The apparatus of claim 1, wherein the anode and cathode are in contact with a groundwater source.

17. The apparatus of claim 1, wherein the anode and cathode are positioned in a groundwater source.

18. The apparatus of claim 1, further comprising a second anode or a second cathode.

19. The apparatus of claim 1, further comprising a pump configured to transfer groundwater from the groundwater source to the anode.

20. The apparatus of claim 1, wherein the power supply comprises AC, DC, solar, wind or hydroelectric power.

21. The apparatus of claim 1, wherein the anode and cathode are in an undivided cell.

22. A method for reduction of contaminants in groundwater comprising:
(a) providing a metal iron anode and a high specific surface area cathode,
(b) placing the groundwater in electrical contact with the anode and cathode, and
(c) providing an electrical current between the anode and the cathode.

23. The method of claim 22, wherein the groundwater is from an aquifer, cistern, well, reservoir, spring, river or lake.

24. The method of claim 22, wherein the method is performed ex-situ.

25. The method of claim 22, wherein the method is performed within the groundwater.

26. The method of claim 22, wherein the method is performed within at least one circulation well.

27. The method of claim 22, wherein the anode comprises at least 90% iron.

28. The method of claim 27, wherein the anode comprises at least 95% iron.

29. The method of claim 22, wherein the anode is cast iron, iron rod, iron plate, or scrap iron.

30. The method of claim 22, wherein the specific surface area is from about 400 m²/m³ to about 6600 m²/m³.

31. The method of claim 30, wherein the specific surface area is from about 1000 m²/m³ to about 6500 m²/m³.

32. The method of claim 31, wherein the specific surface area is from about 5000 m²/m³ to about 6000 m²/m³.

33. The method of claim 22, wherein the cathode comprises metal foam, copper plate or silver plate.

34. The method of claim 33, wherein the cathode comprises copper foam or silver foam.

35. The method of claim 34, wherein the cathode comprises copper foam.

36. The method of claim 22, wherein the cathode has a mean pore size of at least about 100 μM.

37. The method of claim 36, wherein the cathode has a mean pore size of at least about 200 μM.

38. The method of claim 22, wherein the contaminants are halogenated organics.

39. The method of claim 22, wherein the groundwater is fed to the anode from a groundwater source.

40. The method of claim 22, wherein the groundwater is pumped from a groundwater source.

41. The method of claim 22, wherein the groundwater is not treated to modify conductivity.

42. The method of claim 22, wherein the cell is undivided.
